(19) United States
(12) Patent Application Publication
(10) Pub. No.: US 2026/0174082 A1
(43) Pub. Date: Jun. 25, 2026

(54) INDOXACARB SUSPENSION CONCENTRATE FORMULATIONS AND METHODS OF USE THEREOF

(71) Applicant: Control Solutions, Inc., Pasadena, TX (US)

(72) Inventors: Mark Allen Boyd, Seabrook, TX (US); Marie Ann Knox, Lighthouse Point, FL (US); Janis Johnson Reed, Seabrook, TX (US); J. Chance Peck-Pearce, Pasadena, TX (US); Jacob Nathaneil King, Houston, TX (US)

(21) Appl. No.: 19/431,824

(22) Filed: Dec. 23, 2025

Related U.S. Application Data
(63) Continuation-in-part of application No. 19/000,003, filed on Dec. 23, 2024, now Pat. No. 12,527,326.

(51) Int. Cl. A01N 43/88; A01N 25/04; A01P 7/04

(52) U.S. Cl. CPC A01N 43/88; A01N 25/04; A01P 7/04

(57) ABSTRACT

Pesticidal compositions and methods of use are provided. An aqueous pesticidal suspension composition comprises indoxacarb, a dispersant, a surfactant, and water, wherein the dispersant and surfactant are present in amounts effective to maintain the indoxacarb as a stable suspension during storage. The composition may optionally include one or more formulation additives such as a thickener, preservative, antifreeze agent, or antifoaming agent. A suspension concentrate comprising higher levels of indoxacarb, dispersant, and surfactant is also provided and may be diluted prior to application. Methods of controlling pests are further disclosed, including applying an effective amount of an indoxacarb-containing composition to turfgrass or ornamental plants to control pests such as black cutworm larvae, tawny mole cricket, and Genista caterpillar. The compositions may be applied directly or as diluted spray solutions at selected application rates to provide effective pest control with acceptable plant safety.

### CROSS-REFERENCE TO RELATED APPLICATION

This application is a continuation-in-part of U.S. patent application Ser. No. 19/000,003, filed on Dec. 23, 2024, the entire disclosure of which is hereby incorporated by reference in its entirety.

### FIELD OF INVENTION

The present disclosure provides pesticidal compositions comprising pesticidally active solid particulates of voltage-dependent sodium channel blockers.

### BACKGROUND

Indoxacarb exhibits activity against a broad range of insect pests and has been used to control pests across multiple insect orders in both agricultural and non-agricultural settings. Commercially, indoxacarb has been delivered in a variety of formulation types, including solvent-based emulsifiable concentrates (ECs) and solid formulations such as wettable dispersible granules (WDGs) for crop and non-crop uses including turf and ornamental plantings.

These formulation types can present different practical challenges. Solvent-based EC formulations may be associated with plant-safety concerns under certain use conditions, particularly on sensitive plant tissue and highly managed turfgrass. In contrast, WDG and other solid particulate formulations may reduce solvent exposure but may be abrasive to application equipment, contributing to wear of pumps, hoses, fittings, and other components, and may also present dispersion and handling issues during mixing and application.

Accordingly, there remains a need for indoxacarb formulations that combine the handling advantages of a pourable liquid with the plant safety associated with water-based systems, while providing stable dispersion during storage and after dilution, reduced equipment wear, and effective pest control for applications such as structures, turfgrass, ornamental plants, and trees. In some applications, it is desirable to provide a high-active-content aqueous suspension concentrate that is storage-stable and readily dilutable with water to form a uniform spray suspension.

### BRIEF SUMMARY

One aspect of the disclosure is directed to suspension concentrates comprising indoxacarb in a high-active-content, storage-stable, pourable liquid formulation. The suspension concentrate may include about 45% to about 50% by weight indoxacarb, about 10% to about 12% by weight of a dispersant, and about 2% to about 5% by weight of a surfactant. The dispersant and surfactant may be present in amounts effective to maintain the indoxacarb as a stable suspension during storage. The dispersant may be selected from polymeric dispersants, lignosulfonates, naphthalene sulfonate condensates, polycarboxylates, and combinations thereof, and the surfactant may be selected from non-ionic, anionic, cationic, amphoteric surfactants, and combinations thereof. The suspension concentrate may optionally further comprise one or more of a thickener, preservative, antifreeze agent, and/or antifoaming agent, and may be readily dilutable with water while maintaining uniform dispersibility and handling properties. The suspension concentrate may be formulated as a storage-stable, pourable liquid suitable for dilution with water prior to application, while maintaining uniform dispersibility and handling properties.

The disclosure is further directed to a pesticidal suspension composition comprising indoxacarb dispersed in an aqueous medium. The composition may include about 5% to about 30% by weight indoxacarb, about 4.5% to about 6% by weight of a dispersant, about 1% to about 2% by weight of a surfactant, and water. The dispersant and surfactant may be present in amounts effective to maintain the indoxacarb as a stable suspension during storage, thereby reducing settling and facilitating uniform application. The pesticidal suspension composition may be formulated as a pourable liquid suitable for dilution with water prior to application and may provide effective pesticidal activity while maintaining acceptable physical stability under storage conditions. The composition may optionally further comprise one or more of a thickener, preservative, antifreeze agent, and/or antifoaming agent.

The disclosure further relates to methods of controlling turfgrass and ornamental pests by applying an effective amount of a pesticide composition comprising indoxacarb to a target area. In certain embodiments, the composition comprises about 15% to about 25% by weight indoxacarb (or about 20% to about 25% by weight indoxacarb) and is applied to turfgrass or ornamental plants at a rate of about 0.1 to about 0.9 fluid ounces of product per 1,000 square feet of treated area, or as a diluted spray solution at about 1.1 to about 2.9 fluid ounces of product per 100 gallons of water. The pests controlled may include black cutworm larvae (including on cool-season turfgrass), tawny mole cricket (including on warm-season turfgrass), and Genista caterpillar (including on ornamental plants). In some embodiments, application reduces feeding damage by the pests and controls the pests without causing phytotoxicity to the ornamental plants under labeled use conditions.

### BRIEF DESCRIPTION OF THE DRAWINGS

FIG. 1A is a graph showing mean percent mortality of mosquitoes exposed to indoxacarb suspension concentration according to some embodiments of the present disclosure.

FIG. 1B is a graph showing mean percent mortality of mosquitoes exposed to indoxacarb suspension concentration according to some embodiments of the present disclosure.

FIG. 1C is a graph showing mean percent mortality of mosquitoes exposed to indoxacarb suspension concentration according to some embodiments of the present disclosure.

FIG. 2 is a graph showing mean percent mortality of crickets exposed to indoxacarb suspension concentration according to some embodiments of the present disclosure.

FIG. 3 is a bar graph illustrating the percent control of black cutworm obtained following application of three insecticidal treatments to cool-season turf according to some embodiments of the present disclosure.

FIG. 4 is a bar graph illustrating tawny mole cricket counts observed on warm-season turfgrass at multiple time points following application of insecticide treatments according to some embodiments of the present disclosure.

FIG. 5 is a bar graph illustrating turf damage ratings associated with tawny mole cricket infestation on warm-season turfgrass following application of insecticide treatments according to some embodiments of the present disclosure.

FIG. 6 is a bar graph illustrating percent control of tawny mole cricket on warm-season turfgrass at multiple time points following application of insecticide treatments according to some embodiments of the present disclosure.

FIG. 7 is a bar graph illustrating percent feeding damage caused by Genista caterpillar on ornamental plants at multiple time points following application of insecticide treatments according to some embodiments of the present disclosure.

### DETAILED DESCRIPTION

The present disclosure is based in part on the discovery that voltage-dependent sodium channel blockers, when applied in the form of a solid particulate, have surprisingly and counter-intuitively exhibited stability in formulation when compared to industry standard emulsifiable concentrate and water dispersible granule compositions. Importantly, the ability to control current and future generations of pests with currently used application equipment and without concern for damaging the plants where the application is occurring greatly simplifies pest management programs, increases the chance of operators rotating active ingredients thus decreasing the chances of resistance to pesticides, and therefore reducing fecundity further decreases the propagation of any pesticide-resistant traits already present in the adults by diminishing the size of the future generation.

The present disclosure relates to pesticidal suspension compositions and methods of using the compositions. The compositions are aqueous and comprise indoxacarb particles dispersed in water. The compositions may be configured such that the dispersant and surfactant are present in amounts effective to maintain the indoxacarb as a stable suspension during storage, including the ability to be readily re-dispersed after standing.

### I. COMPOSITIONS

One aspect of the disclosure encompasses a pesticidal composition comprising a pesticidally effective concentration of a voltage-dependent sodium channel blocker in solid particulate form.

Voltage-gated sodium channels are integral transmembrane proteins that are critical for electrical signaling in excitable cells. Upon membrane depolarization, sodium channels open and permit influx of sodium ions, driving the rapid rising phase of the action potential. Shortly after opening, the channel undergoes fast inactivation, in which the channel pore is occluded, contributing to termination of the action potential and preventing excessive depolarization. Because of their central role in cellular excitability, sodium channels represent an effective target for pesticidal control.

In one embodiment, the voltage-dependent sodium channel blocker comprises indoxacarb, metaflumizone, or a combination thereof.

As explained above, the inventors discovered that voltage-dependent sodium channel blocker, when applied in solid particulate form, may be formulated and applied to effectively control pests. As used herein, the terms “solid particulate voltage-dependent sodium channel blocker,” “voltage-dependent sodium channel blocker in solid particulate form,” and “solid particulate form of a voltage-dependent sodium channel blocker” may be used interchangeably and refer to a solid form of the voltage-dependent sodium channel blocker.

The size of the solid particulate of voltage-dependent sodium channel blocker may be selected based on factors such as the particular active ingredient, the target pest to be controlled, the method of application, and the intended site of application, among other variables, provided the particles are compatible with the intended composition and delivery technique. For instance, in powder formulations intended for application into the pest environment, the particles may be sized to promote dispersability in the environment. Similarly, in suspension formulations, the particles may be sized to promote and maintain dispersability of the composition in a suspending vehicle. In some embodiments, the composition is applied as a powder on a carrier granule, for example, by depositing the powder composition onto the carrier granules.

In some embodiments, the solid particulate voltage-dependent sodium channel blocker has a particle size of about 5 μm or less, 4 μm or less, 3 μm or less, 2 μm or less, 1 μm or less, or 0.5 μm or less. In some embodiments, the particle size is about 2.1 μm or less.

The voltage-dependent sodium channel blocker may be present in the composition in a pesticidally effective amount. In some embodiments, the amount of voltage-dependent sodium channel blocker ranges from about 5.0% to about 25% by weight (w/w). For example, the amount may range from 6.0% w/w to about 24 w/w %, 7.0% w/w to about 23 w/w %, 8.0% w/w to about 22 w/w %, 9.0% w/w to about 21 w/w %, 10.0% w/w to about 20 w/w %, 11.0% w/w to about 19 w/w %, 12.0% w/w to about 18 w/w %, 13.0% w/w to about 17 w/w %, or 14.0% w/w to about 16 w/w %.

In one embodiment, the voltage-dependent sodium channel blocker is indoxacarb. In certain embodiments, indoxacarb is present in a pesticidally effective amount ranging from about 5% to about 25% by weight

In some embodiments, the pesticidal composition further comprises an insect growth regulator (IGR). IGRs are compounds that inhibit the life cycle of an insect, for example by interfering with the molting process. Suitable IGRs include hormonal IGRs or chitin synthesis inhibitors.

Non-limiting examples of hormonal IGRs include methoprene, hydroprene, kinoprene, fenoxycarb, pyriproxyfen, and combinations thereof. In one embodiment, the hormonal IGR is pyriproxyfen.

In certain embodiments, the IGR is a chitin synthesis inhibitor. Chitin synthesis inhibitors prevent the formation of chitin, a carbohydrate needed to form the insect's exoskeleton. Chitin synthesis inhibitors may include a broad class of benzoylphenylurea, as disclosed in U.S. Pat. No. 5,886,221 (incorporated herein by reference in its entirety). Non-limiting examples of suitable benzoylureas include chlorfluazuron, cyramazin, diflubenzuron, noviflumuron, flucycloxuron, flufenoxuron, hexaflumuron, lufenuron, novaluron, teflubenzuron, diflubenzuron, triflumuron, buprofezin, diofenolan, hexythiazox, etoxazole, clofentazine, lufenuron, chlorfluazuron, bistrifluron, triflumuron, and combinations thereof. In certain embodiments, the chitin synthesis inhibitor is novaluron, diflubenzuron, lufenuron, or combinations thereof.

In some embodiments, the chitin synthesis inhibitor is present as a pesticidally active solid particulate. In some embodiments, the chitin synthesis inhibitor particles may have a particle size of about 15 μm or less, and the chitin synthesis inhibitor may provide pesticidal activity irrespective of the development stage of the pest.

The compositions may be formulated for application as a suspension or as a solid to control pests, depending on the target pest to be controlled as well as the method used for controlling the pest. For instance, if the target pest is a termite, the composition may be formulated as a powder and can further comprise an environmentally mimicking agent that mimics or is compatible with the environment of the termite. Similarly, the pesticidally effective concentration of solid particulate voltage-dependent sodium channel blockers in the composition can and will change depending on the target pest to be controlled as well as the intended use of the composition. In some embodiments, voltage-dependent sodium channel blockers of the instant disclosure may be formulated as a solid or as a suspension.

### Solid Compositions

In some embodiments, the compositions are formulated as a solid according to methods well known in the art. For instance, the compositions may be formulated as a powder, granules, or any other solid form suitable for delivery of a pesticide. In one embodiment, the compositions are formulated as a powder. It will be recognized that powder compositions can further be compressed into other solid forms, including granules or blocks.

In certain embodiments, the composition is formulated into a powder comprising the solid particulate voltage-dependent sodium channel blocker. Powder formulations are known in the art and generally comprise one or more of anticaking agents, dispersants and fillers, among other ingredients. Pesticidal powder compositions are generally applied as a dust to provide superior access to cracks and crevices that many insecticide sprays may miss for better overall pest control. Ingredients that may be used in powder formulations are described further below in this section. It will be recognized that one or more of the components can exhibit more than one characteristic of the ingredients of the composition. For instance, when a composition of the disclosure comprises a clay ingredient, the clay may be an anticaking agent used to maintain the flowability of the composition, an environmentally mimicking agent for use as a building material by, e.g., termites, and a filler.

Powder compositions can also be applied onto a carrier such as carrier granules prior to application such as by broadcast distribution. Accordingly, one aspect of the present disclosure encompasses a pesticidal granule comprising a carrier granule having a powder composition of voltage-dependent sodium channel blockers deposited thereon (voltage-dependent sodium channel blocker granules). It will be recognized that a sufficient amount of the powder composition is deposited onto the carrier granules to provide a pesticidally effective concentration of the inhibitor. The pesticidally effective concentration can and will vary depending on the voltage-dependent sodium channel blocker, the method of depositing the powder onto the carrier granules, the application rate of the carrier granules, the target pest to be controlled, and the site where control of a target pest is sought, and may be determined experimentally.

The powder composition may be deposited onto carrier granules by simply spraying onto or combining the powder composition with the carrier granules. Alternatively, the powder composition may be adhered to the carrier granules using a tackifying agent. A suitable carrier granule is any granule well sized for the method of distribution of the granules, such as by broadcast distribution. For instance, a carrier granule can have a size ranging from about 0.1 millimeter to about 5 centimeters, from about 0.5 to about 2 centimeters, or from about 0.1 to about 5 millimeters. The granules are generally inert towards the voltage-dependent sodium channel blocker when applied thereon. Suitable carrier granules include fragmented materials such as rock dust, clay, corncob, cereal or grain hulls, peanut hulls, plant pulp, other plant-based cellulosic materials, clays, granular baits, and fertilizers. Non-limiting examples of carrier granules include: limestone particulate; fertilizer granules; and extruded corn granules. In certain embodiments, the carrier granules disintegrate after distribution. In certain embodiments, the carrier granules are dissolvable carrier granules. In certain embodiments, when the granule is a fertilizer granule and the voltage-dependent sodium channel blocker is indoxacarb, the voltage-dependent sodium channel blocker granules comprise indoxacarb ranging from about 6.0% to about 10% indoxacarb by wt, from about 10% to about 15% indoxacarb by wt, from about 15% to about 20% indoxacarb by wt, or from about 20% to about 25% indoxacarb by wt.

In certain embodiments, the powder composition comprises solid particulate indoxacarb. When the composition comprises solid particulate indoxacarb, the powder compositions may comprise indoxacarb at a concentration of about 6.0% w/w or more. For instance, the composition may comprise solid particulate indoxacarb at a concentration of about 6.0% w/w, 6.1% w/w, 6.2% w/w, 6.3% w/w, 6.4% w/w, 6.5% w/w, 6.6% w/w, 6.7% w/w, 6.8% w/w, 6.9% w/w, 7.0% w/w, 7.1% w/w, 7.2% w/w, 7.3% w/w, 7.4% w/w, 7.5% w/w, 7.6% w/w, 7.7% w/w, 7.8% w/w, 7.9% w/w, 8.0% w/w, 8.1% w/w, 8.2% w/w, 8.3% w/w, 8.4% w/w, 8.5% w/w, 8.6% w/w, 8.7% w/w, 8.8% w/w, 8.9% w/w, 9.0% w/w, 9.1% w/w, 9.2% w/w, 9.3% w/w, 9.4% w/w, 9.5% w/w, 9.6% w/w, 9.7% w/w, 9.8% w/w, 9.9% w/w, 10% w/w, 10.5% w/w, 11% w/w, 11.5% w/w, 12% w/w, 12.5% w/w, 13% w/w, 13.5% w/w, 14%, w/w 14.5% w/w, 15% w/w, 15.5% w/w, 16% w/w, 16.5% w/w, 17% w/w, 17.5% w/w, 18% w/w, 18.5% w/w, 19% w/w, 19.5% w/w, 20% w/w, 20.1% w/w, 20.2% w/w, 20.3% w/w, 20.4% w/w, 20.5% w/w, 20.6% w/w, 20.7% w/w, 20.8% w/w, 20.9% w/w, 21% w/w, 21.5% w/w, 22% w/w, 22.5% w/w, 23% w/w, 23.5% w/w, 24% w/w, 24.5% w/w, 25% w/w or more. In one aspect, the composition comprises solid particulate indoxacarb at a concentration of about 7.0% w/w or more. In one embodiment, the composition comprises solid particulate indoxacarb at a concentration of about 6.4% w/w or more. In another embodiment, the composition comprises solid particulate indoxacarb at a concentration of about 20.9% w/w or more.

### Anticaking Agent

The compositions may comprise one or more anticaking agents. As used herein, the term “anticaking agent” is an additive placed in powdered or granulated materials to prevent the lump formation (caking) and to improve handling characteristics such as packaging, transport, and flowability. Caking can occur through various mechanisms depending on the material, including formation of liquid bridges and fusion of microcrystals in crystalline solids, glass transitions and viscosity changes in amorphous materials, and polymorphic phase transitions. Common anticaking agents include calcium and magnesium stearates, silica and silicates, talc, flour, and starch. Non-limiting examples of anticaking agents include tricalcium phosphate, crushed limestone, powdered cellulose, magnesium stearate, sodium bicarbonate, sodium ferrocyanide, potassium ferrocyanide, calcium ferrocyanide, bone phosphate (i.e., calcium phosphate), sodium silicate, silicon dioxide, calcium silicate, magnesium trisilicate, talcum powder, sodium aluminosilicate, potassium aluminum silicate, calcium aluminosilicate, bentonite, aluminum silicate, stearic acid, and polydimethylsiloxane. In certain embodiments, the anticaking agent comprises crushed limestone.

### Environmentally Mimicking Agent

The compositions may comprise one or more environmentally mimicking agents. As used herein, the term “environmentally mimicking agent” may be any powder ingredient that mimics, or is compatible with, the environment of a pest. The environmentally mimicking agent may be an edible ingredient. The environmentally mimicking agent can also be a building material. Additionally, the environmentally mimicking ingredient can mimic material normally found in the environment of the organism without necessarily being of use to the pest as food or building material. When the composition is a delayed acting composition, the environmentally mimicking agent is non-toxic, non-hydrophilic, and prevents desiccation and cuticle shredding exhibited by other, industrially common, environmentally mimicking agents such as carboxylated cellulose.

Non-limiting examples of suitable environmentally mimicking agents include powdered cellulosic materials, powdered clays including powdered attapulgite, powdered bentonite, powdered chitinous materials, powdered montmorillonite, powdered kaolinite, powdered vermiculite, powdered dolomite, calcium silicates, aluminum silicates, and combinations thereof.

### Filler

Any filler may be used provided the filler has not demonstrated repellant properties on target pest(s). Non-limiting examples of fillers include carbohydrates, inorganic compounds, inert non-food organic materials, crushed minerals, crushed non-perishable food or food-byproducts and biocompatible polymers, such as polyvinylpirrolydone (PVP). Other non-limiting examples of fillers include dibasic calcium sulfate, tribasic calcium sulfate, starch, calcium carbonate, magnesium carbonate, microcrystalline cellulose, dibasic calcium phosphate, tribasic calcium phosphate, magnesium carbonate, brewer's yeast, corn grit, powdered clays including powdered attapulgite, powdered bentonite, powdered chitinous materials, powdered montmorillonite, powdered kaolinite, powdered vermiculite, powdered dolomite, magnesium oxide, calcium silicate, talc, modified starches, saccharides such as sucrose, dextrose, lactose, microcrystalline cellulose, fructose, xylitol, and sorbitol, polyhydric alcohols; starches; pre-manufactured direct compression diluents; and mixtures of any of the foregoing. In certain embodiments, the filler is attapulgite.

### Suspension Compositions

In some embodiments, the composition is formulated as a suspension comprising the solid particulate voltage-dependent sodium channel blocker according to methods well known in the art. As used herein, the term “suspension composition” refers to liquid compositions comprising solid particles of voltage-dependent sodium channel blocker stably distributed somewhat uniformly throughout the suspending medium (suspending vehicle) in which the voltage-dependent sodium channel blocker exhibits a minimum degree of solubility. Accordingly, a suspension composition of the instant disclosure is free of a solvent that can solubilize the voltage-dependent sodium channel blocker.

Suspension compositions may be formulated as a liquid, gel, lotion, aerosol, foam, or cream composition containing, carriers, excipients, and vehicles as desired. Accordingly, in addition to a suspending vehicle, compositions can further comprise ingredients suitable for the intended formulation, including dispersants, stabilizers, surfactants, glidants, antifoaming agents, thickeners, antifreeze agents, solid carriers, chelating agents, antimicrobial agents, release-controlling polymers, and combinations of any thereof. As explained above, one or more of the components can exhibit more than one characteristic of the ingredients of the composition. For instance, when a composition of the disclosure comprises a clay ingredient, the clay may be a suspension aid or a dispersant.

The suspending vehicle can and will vary depending on the particular voltage-dependent sodium channel blocker, the formulation, and the intended use of the composition. In certain embodiments, the suspending vehicle is an aqueous vehicle. In one aspect the suspending vehicle is water.

A suspension composition further comprises at least one surfactant. In certain embodiments, the surfactant is a non-ionic surfactant. The inventors surprisingly discovered that a suspension composition of the instant disclosure is significantly more pesticidally effective when the composition further comprises a non-ionic surfactant. In certain embodiments, the surfactant is a non-ionic siloxane or siloxane-based surfactant. Non-limiting examples of non-ionic siloxane-based surfactants include tri-siloxane surfactants having the general structure Me₃SiO—SiMeR—OSiMe₃ such as Break-Thru® S 233, Step-Flow® 26 F. In one aspect, the non-ionic surfactant is Break-Thru® S 233. In one aspect, the surfactant is tristyrylphenol phosphate surfactant (Soprophor® FLK).

In some embodiments, the suspension composition is a suspension concentrate. Accordingly, one embodiment of the present disclosure encompasses a pesticidal composition comprising a suspension composition obtained from a suspension concentrate, wherein the voltage-dependent sodium channel blocker is at a pesticidally effective concentration suitable for application of the inhibitor. The pesticidally effective concentration can and will vary depending on the voltage-dependent sodium channel blocker, the method of application of the diluted concentrate, the application rate of the diluted concentrate, the target pest to be controlled, and the site where control of a target pest is sought, and may be determined experimentally.

The liquid used for diluting a suspension concentrate of the instant disclosure can and will vary depending on the voltage-dependent sodium channel blocker, suspension concentrate, the method of application of the concentrate, the application rate of the diluted concentrate, the target pest to be controlled, and the site where control of a target pest is sought, and may be determined experimentally. In certain embodiments, the liquid is the same as the suspending vehicle of the suspension concentrate. For instance, when the suspending vehicle of a suspension concentrate is water, the suspension concentrate can further be diluted into water before application.

Suspension compositions can also be applied onto a carrier such as carrier granules prior to application such as by broadcast distribution. Accordingly, one aspect of the present disclosure encompasses a pesticidal granule comprising a carrier granule having a suspension composition of voltage-dependent sodium channel blockers deposited thereon (voltage-dependent sodium channel blocker granules). In certain embodiments, the suspension composition deposited onto the carrier granule is a suspension concentrate. In certain embodiments, the suspension composition deposited onto the carrier granule is a suspension composition diluted from a suspension concentrate.

It will be recognized that a sufficient amount of the suspension composition is deposited onto the carrier granules to provide a pesticidally effective concentration of the inhibitor. The pesticidally effective concentration can and will vary depending on the voltage-dependent sodium channel blocker, the suspension concentrate, the method of depositing the concentrate onto the carrier granules, the application rate of the carrier granules, the target pest to be controlled, and the site where control of a target pest is sought, and may be determined experimentally.

The voltage-dependent sodium channel blocker suspension may be deposited onto carrier granules by simply spraying onto or combining the suspension concentrate with the carrier granules. Alternatively, the voltage-dependent sodium channel blocker may be adhered to the carrier granules using a tackifying agent. A suitable carrier granule is any granule well sized for the method of distribution of the granules, such as by broadcast distribution. For instance, a carrier granule can have a size ranging from about 0.1 millimeter to about 5 centimeters, from about 0.5 to about 2 centimeters, or from about 0.1 to about 5 millimeters. The granules are generally inert towards the suspension concentrate when applied thereon. Suitable carrier granules include fragmented materials such as rock dust, clay, corncob, cereal or grain hulls, peanut hulls, plant pulp, other plant-based cellulosic materials, clays, granular baits, and fertilizers. Non-limiting examples of carrier granules include: limestone particulate; fertilizer granules; and extruded corn granules. In certain embodiments, the carrier granules disintegrate after distribution. In certain embodiments, the carrier granules are dissolvable carrier granules. In certain embodiments, the carrier granules are a fertilizer particle wherein the suspension composition is sprayed thereon for co-application of the fertilizer and voltage-dependent sodium channel blocker. In certain embodiments, when the granule is a fertilizer granule and the voltage-dependent sodium channel blocker is indoxacarb, the voltage-dependent sodium channel blocker granules comprise indoxacarb ranging from about 6.0% to about 10% indoxacarb by wt, from about 10% to about 15% indoxacarb by wt, from about 15% to about 20% indoxacarb by wt, or from about 20% to about 25% indoxacarb by wt.

In certain embodiments, the suspension composition comprises solid particulate indoxacarb. In certain embodiments, the suspension composition is provided as a suspension concentrate comprising solid particulate indoxacarb. The suspension concentrate may comprise indoxacarb in an amount ranging from about 0.001% w/w to about 80% w/w or more, including, for example, about 0.01% w/w to about 80% w/w, about 1% w/w to about 50% w/w, about 30% w/w to about 60% w/w, or about 5% w/w to about 15% w/w. In certain embodiments, the suspension concentrate comprises indoxacarb in an amount of about 35% w/w to about 55% w/w. In certain embodiments, the suspension concentrate comprises indoxacarb in an amount of about 0.05% w/w to about 1% w/w, such as about 0.08% w/w to about 0.7% w/w.

### Surfactant

The surfactant may be anionic, cationic surfactants, zwitterionic surfactants, and non-ionic surfactants. Anionic surfactants may be sulfate, sulfonate, and phosphate, carboxylate derivatives. Non-limiting examples of anionic surfactants include ammonium lauryl sulfate, sodium lauryl sulfate (sodium dodecyl sulfate, SLS, or SDS), and the related alkyl-ether sulfates sodium laureth sulfate (sodium lauryl ether sulfate or SLES), and sodium myreth sulfate, docusate (dioctyl sodium sulfosuccinate), perfluorooctanesulfonate (PFOS), perfluorobutanesulfonate, alkyl-aryl ether phosphates, alkyl ether phosphates, sodium stearate, sodium lauroyl sarcosinate and carboxylate-based fluorosurfactants such as perfluorononanoate, and perfluorooctanoate (PFOA or PFO). Non-limiting examples of cationic surfactants include octenidine dihydrochloride, cetrimonium bromide (CTAB), cetylpyridinium chloride (CPC), benzalkonium chloride (BAC), benzethonium chloride (BZT), dimethyldioctadecylammonium chloride, and dioctadecyldimethylammonium bromide (DODAB). Non-limiting examples of zwitterionic surfactants include CHAPS (3-[(3-cholamidopropyl)dimethylammonio]-1-propanesulfonate), lauryldimethylamine oxide, and myristamine oxide. Suitable non-ionic surfactants include emulsifying wax, glyceryl monooleate, polyoxyethylene alkyl ethers, polyoxyethylene castor oil derivatives, polysorbate, sorbitan esters, benzyl alcohol, benzyl benzoate, cyclodextrins, glycerin monostearate, poloxamer, povidone and combinations thereof. In one embodiment, the non-ionic surfactant is stearyl alcohol. Non-limiting examples of non-ionic surfactants include octaethylene glycol monododecyl ether, pentaethylene glycol monododecyl ether, nonoxynols, Triton X-100, polyEthox®ylated tallow amine, cocamide monoethanolamine, cocamide diethanolamine, polaxamers, glycerol monostearate, glycerol monolaurate, sorbitan monolaurate, sorbitan monostearate, sorbitan tristearate, Tween 20, Tween 40, Tween 60, Tween 80, decyl glucoside, lauryl glucoside, octyl glucoside, siloxane surfactants, and combinations thereof.

The composition may further include one or more surfactants to promote wetting, dispersion, and suspension stability.

In some embodiments, the surfactant comprises one or more non-ionic surfactants. The non-ionic surfactants may offer compatibility with a wide range of dispersants and formulation components.

### Suspension Aid

A suspension aid may be added to help maintain the solid particulate voltage-dependent sodium channel blocker in suspension, thus improving the particle's resistance to settle statically and flow under shear or rheological shear-thinning. Suitable suspension aids include, but are not limited to, water soluble polymers such as 3-butoxy-2-hydroxypropylhydroxyethylcellulose, acrylamide homo- and copolymers, acrylic acid homo- and copolymer, alginates, carboxymethylcellulose (sodium and other salts), carboxymethylhydroxyethylcellulose, carboxy-vinyl copolymers, cellulose, guar gum, gum arabic; hydrophobically modified hydroxyethylcellulose, hydroxyethylcellulose, hydroxypropyl guar, hydroxypropyl methylcellulose, hydroxypropylcellulose, natural gums and their derivatives, partially and fully hydrolyzed polyvinyl alcohols, partially neutralized polyacrylic acid, polyalkylene glycol, polysaccharide gums, polyvinylpyrrolidone and derivatives, sodium carboxymethylcellulose, starch and its derivatives, vinylpyrrolidone homo- and copolymers, water-soluble cellulose ethers, xanthan gum, and mixtures thereof. Other suspension aids may be silica powder prepared by precipitating water glass (sodium silicate) with sulfuric acid, which is then dried and sold as a fine powder. The silica powder provides a rheology control and aids in suspension by preventing particle settling. Still another suspension aid material may be fumed alumina. Alumina or aluminum oxide is an amphoteric oxide of aluminum with the chemical formula Al₂O₃. Fumed alumina is made of primary particles which sinter together to form aggregates. These alumina aggregates have a chain-like structure and an average diameter of 150 nm (for primary particle size of 20 nm). It also provides a rheology control and lubrication for the particle suspension. Clays can also be used as suspension aids. Such clays include bentonite, laponites, kaolinite, dickite, and nacrite, with the general formula of Al₂Si₂O₅(OH)₄; pyrophylite, talc, vermiculite, sauconite, saponte, nontronite, and montmorillonite with the general chemical formula (Ca, Na, H) (Al, Mg, Fe, Zn)₂ (Si, Al)₄O₁₀(OH)₂·xH₂O; attapulgite with the general chemical formula Mg₅Si₈O₂0(HO)₂(OH₂)₄·4H₂O; and illite with the general formula (K, H) Al₂(Si, Al)₄O10(OH)₂·xH₂O, and organically modified montmorillonite clays.

### Dispersant

One or more dispersants, in combination with at least one surfactant (described below), stabilizes the resulting aqueous formulation by lowering the surface tension and preventing agglomeration of the spore particles.

The dispersant(s) may be ionic or non-ionic and polymeric in structure. Ionic water soluble polymers include lignin-based dispersants such as lignin sulfonates, which are water soluble polymers that carry ionic charge along the backbone chain, including ammonium, sodium, calcium and magnesium ions.

The pesticidal suspension composition may comprise one or more dispersants configured to assist in wetting, dispersing, and stabilizing the indoxacarb particles within the aqueous medium.

Suitable dispersants include, but are not limited to, polymeric dispersants, lignosulfonates, naphthalene sulfonate condensates, polycarboxylates, or combinations thereof.

In some embodiments, the dispersant comprises one or more polymeric dispersants. Examples of polymeric dispersants include polyether-based polymeric dispersants, polyacrylate dispersants, acrylic copolymers, polyvinyl alcohol derivatives, block copolymers, or combinations thereof.

In particular embodiments, the dispersant may be a polyether-based polymeric dispersant. The polyether-based polymeric dispersant may provide enhanced dispersion stability and resistance to particle agglomeration.

### Antifoaming Agent

An antifoaming agent may be included to reduce or suppress foam formation during manufacturing, mixing, dilution, or application of the composition. Excessive foaming can interfere with processing efficiency, accurate dosing, and uniform application.

An antifoaming agent or a defoamer is a chemical additive that reduces and hinders the formation of foam in industrial process liquids. The terms antifoaming agent and defoamer are often used interchangeably. Strictly speaking, defoamers eliminate existing foam, and antifoamers prevent the formation of further foam. Commonly used agents are insoluble oils, polydimethylsiloxanes and other silicones, certain alcohols, stearates and glycols. The additive is used to prevent formation of foam or is added to break a foam already formed. Oil-based defoamers have an oil carrier. The oil might be mineral oil, vegetable oil, white oil, or any other oil that is insoluble in the foaming medium, except silicone oil. An oil-based defoamer can also contain a wax and/or hydrophobic silica to boost the performance. Typical waxes are ethylene bis stearamide (EBS), paraffin waxes, ester waxes, and fatty alcohol waxes. These products might also have surfactants to improve emulsification and spreading in the foaming medium. Powder defoamers are in principle oil-based defoamers on a particulate carrier like silica. Water-based defoamers are different types of oils and waxes dispersed in a water base. The oils are often mineral oil or vegetable oil and the waxes are long chain fatty alcohol, fatty acid soaps, or esters. Silicone-based defoamers are polymers with silicon backbones. These might be delivered as an oil or a water-based emulsion. The silicone compound consists of a hydrophobic silica dispersed in a silicone oil. Emulsifiers are added to ensure that the silicone spreads fast and well in the foaming medium. The silicone compound might also contain silicone glycols and other modified silicone fluids. These are also heavy duty defoamers and are good at both knocking down surface foam and releasing entrained air. Silicone-based defoamers are also suitable in non-aqueous foaming systems like crude oil and oil refining. For very demanding applications, fluorosilicones may be suitable. EO/PO based defoamers contain polyethylene glycol and polypropylene glycol copolymers. They are delivered as oils, water solutions, or water-based emulsions. EO/PO copolymers normally have good dispersing properties and are often well suited when deposit problems are an issue. Alkyl polyacrylates are suitable for use as defoamers in non-aqueous systems where air release is more important than the breakdown of surface foam. These defoamers are often delivered in a solvent carrier like petroleum distillates. In certain embodiments, the antifoaming agent is a silicone-based antifoaming agent such as SAG™ 30.

### Antifreeze Agents

Antifreeze agents may optionally be included to improve the low-temperature stability of the composition and to reduce or prevent freezing during storage, transportation, or handling under cold conditions. Freezing of aqueous suspension compositions may adversely affect physical stability, such as by causing phase separation, aggregation of suspended particles, or changes in viscosity.

Any substance capable of lowering the freezing point of water and protecting a system from the ill effects of ice formation may optionally be used in the instant disclosure, provided the antifreeze is compatible with the compositions of the disclosure. Non-limiting examples of antifreezes include ethylene glycol or propylene glycol, methanol, isopropanol, glycerol, dimethyl sulfoxide, trehalose, and combinations thereof.

### Other Ingredients

Other ingredients that may optionally be included in compositions of the present disclosure may include diluents, preservatives, chelating agents, and antimicrobial agents, among others. These ingredients are described in greater detail below.

### Pesticidal Ingredient

The composition may optionally comprise one or more pesticides in addition to the solid particulate voltage-dependent sodium channel blocker. The additional component may be in the particles or it may be in the composition, it may be solid or not, depending on the function of the pesticide.

Pesticides are defined as chemicals used to kill pests. Pesticides include insecticides and acaricides. The pesticides may be ingestion-active or systemic pesticides. Alternatively, the pesticides may be contact pesticides. Pesticides may be ovicides or substances that kill eggs, larvicides or substances that kill larvae, or adulticides or substances that kill adult insects. Several types of pesticides are described in more detail below.

Irrespective of the type of pesticide, the pesticide and the concentration of the pesticide must be appropriate for the desired activity of the composition. For instance, when a composition is a delayed acting composition for translocation into a colony or to be shared among pests in the environment of the pest, the type and amount of pesticides in the composition must allow sufficient activity latency to facilitate translocation of the composition to other pests. Delayed activity may be inherent to the pesticide. Alternatively, the delayed activity may be controlled by the concentration of the pesticide in the composition. As such, the concentration of a pesticide in a composition of the disclosure can and will vary depending on the pesticide, the target pest among others, and may be determined experimentally for each pesticide.

### Insecticides

An insecticide is a pesticide used against insects in all developmental forms. Insecticides are commonly used in agriculture, medicine, industry, and for household use. Representative insecticides useful in the present invention include pyrethrum type insecticides, such as pyrethrin; pyrethroids, such as deltamethrin, permethrin, β-cyfluthrin, bifenthrin, and resmethrin; nicotinics, particularly chloronicotinyl compounds, such as acetamiprid, imidacloprid, thiamEthox®am, clothianidin, acetamiprid, thiacloprid, and dinotefuran; pyrazoles such as fipronil, ethiprole, and tebufenpyrad; semicarbazones such as indoxacarb and metaflumizone, phthalic acid diamides such as flubendiamide and (S)-3-chloro-N1-{2-methyl-4-[1,2,2,2-tetrafluoro-1-(trifluoromethyl)ethyl]phenyl}-N2-(1-methyl-2-methylsulfonylethyl)phthalamide; anthranilic acid amides such as chloroanthraniliprole; organophosphates such as chlorpyrifos, malathion, and diazinon; carbamates such as bendiocarb, carbaryl, and thiodicarb; ketoenoles such as spirotetramat, spirodiclofen, and spiromesifen; phthalic acid diamides such as insecticides with an active ingredients from the anthranilic diamide class such as that sold by DuPont® under the tradename Rynaxypyr® (hereinafter referred to a rynaxypyr for ease of reference), and flubendiamide; IGRs such as methoprene, pyriproxifen, triflumuron, hexaflumuron, noviflumuron, fenoxycarb; and other insecticides, such as abamectin, hydramethylnon, sulfluramid, and spinosad. Representative chlorinated hydrocarbons include aldrin, chlordane, chlordecone, DDT, dieldrin, endosulfan, endrin, heptachlor, hexachlorocyclohexane, gamma-hexachlorocyclohexane, lindane, mEthox®ychlor, mirex, pentachlorophenol, and TDE. Representative organophosphorus insecticides include acephate, azinphos-methyl, bensulide, chlorEthox®yfos, chlorpyrifos, chlorpyriphos-methylm diazinon, dichlorvos (DDVP), dicrotophos, dimethoate, disulfoton, ethoprop, fenamiphos, fenitrothion, fenthion, fosthiazate, malathion, methamidophos, methidathion, methyl-parathion, mevinphos, naled, omethoate, oxydemeton-methyl, parathion, phorate, phosalone, phosmet, phostebupirim, pirimiphos-methyl, profenofos, terbufos, tetrachlorvinphos, tribufos, trichlorfon. Representative carbamates include aldicarb, carbofuran, carbaryl, methomyl, and 2-(1-methylpropyl)phenyl methylcarbamate. Representative pyrethroids include allethrin, beta-cyfluthrin, bifenthrin, cyfluthrin, deltamethrin, permethrin, resmethrin, sumithrin, tetramethrin, tralomethrin, and transfluthrin. Representative plant toxin derived insecticides include derris (rotenone), pyrethrum, neem (azadirachtin), nicotine, caffeine, and compositions thereof.

Additional insecticides include cyclic ketoenols with insecticidal and acaricidal properties, such as those described in EP 528 156 A, WO 95/01971, EP 647 637 A, WO 96/16061, WO 96/20196, WO 96/25395, WO 96/35664, WO 97/02243, WO 97/01535, WO 97/36868, WO 97/43275, WO 98/05638, WO 98/06721, WO 99/16748, WO 99/43649, WO 99/48869, and WO 99/55673, each hereby incorporated by reference with regard to such teaching. Certain pesticides are exempt from the requirements of the FIFRA act (40 CFR 152.25(f)). They are commonly known as minimum risk pesticides. Examples of these pesticides include castor oil (U.S.P. or equivalent), cedar oil, cinnamon and cinnamon oil, citric acid, citronella and citronella oil, cloves and clove oil, corn gluten meal, corn oil, cottonseed oil, dried blood, eugenol, garlic and garlic oil, geraniol, geranium oil, lauryl sulfate, lemongrass oil, linseed oil, malic acid, mint and mint oil, peppermint and peppermint oil, 2-phenethyl propionate (2-phenylethyl propionate), potassium sorbate, putrescent whole egg solids, rosemary and rosemary oil, sesame (includes ground sesame plant) and sesame oil, sodium chloride (table salt), sodium lauryl sulfate, soybean oil, thyme and thyme oil, and white pepper.

Numerous heterocycles, organotin compounds, benzoylureas and pyrethroids have insecticidal and acaricidal properties, for example, see WO 93/22297, WO 93/10083, DE 2 641 343 A, EP 347 488 A, EP 210 487 A, U.S. Pat. No. 3,264,177, and EP 234 045 A, each herein incorporated by reference with regard to such teaching.

Certain bacteria, fungi, and other biological material may be active as insecticides. When these biological insecticides are inactive against other organisms, some are considered more environmentally friendly than synthetic pesticides. Examples include, but are not limited to, Bacillus sphericus, Bacillus subtilis, Bacillus cereus, or combinations of such material.

In certain embodiments, the pesticide is abamectin, acetamiprid, borax (sodium tetraborate), boric acid, boron sodium oxide, chlorantranaliprole, cyantranaliprole, chlorfenapyr, copper ammonium carbonate, copper carbonate, basic, copper hydroxide, copper quinolate, cupric oxide, diflubenzuron, dinotefuran, fipronil, hexaflumuron, hydramethylnon, imidacloprid, indoxacarb, novaluron, noviflumuron, pyriproxyfen, sodium borate pentahydrate, tebuconazole, thiamEthox®am, or combinations thereof. In certain embodiments, the pesticide is fipronil, indoxacarb, novaluron, pyriproxyfen, chlorfenapyr, or combinations thereof.

### Acaricides

Any suitable acaracide may optionally be used. Examples of suitable acaricides include sumiito (2-tert-butyl-5-(4-tert-butylbenzylthio)-4-chloropyridazine-3-(2H)-one), acricid (2,4-dinitro-6-sec-butylphenyldimethylacrylate), chloromite (isopropyl 4,4-dichlorobenzylate), Akar (ethyl 4,4′-dichlorobenzilate), kelthane (2,2,2trichloro-1,1-bis(p-chlorophenyl)-ethanol), citrazon (benzoic 3-chloro-N-Ethox®y-2,6-dimEthox®ybenzimidic anhydride), omite (2-(p-tert-butylphenoxy)cyclohexyl propyn-2-yl sulfite), osadan (bis[tris(2-methyl-2-phenylpropyl)tin]oxide), hexythiazox (trans-5-(4-chlorophenyl)-N-cyclohexyl-4-methyl-2-oxothiazol-idine-3-carboxamide), and amitraz (N,N-bis(2,4-xylyliminomethyl)methylamine).

### Preservatives

A preservative may optionally be included to inhibit or reduce the growth of microorganisms, such as bacteria, yeasts, and fungi, that may otherwise proliferate in aqueous formulations during storage. Microbial growth can adversely affect the physical stability, chemical integrity, and performance of the pesticidal suspension, for example by causing viscosity changes, phase separation, odor formation, or degradation of formulation components. The inclusion of a preservative, if desired, may improve shelf life and maintain the consistency and quality of the composition over extended storage periods. The preservative may be present in an amount effective to provide antimicrobial protection without adversely affecting the pesticidal efficacy or application properties of the composition.

Non-limiting examples of preservatives include, but are not limited to, ascorbic acid and its salts, ascorbyl palmitate, ascorbyl stearate, anoxomer, N-acetylcysteine, benzyl isothiocyanate, m-aminobenzoic acid, o-aminobenzoic acid, p-aminobenzoic acid (PABA), butylated hydroxyanisole (BHA), butylated hydroxytoluene (BHT), caffeic acid, canthaxantin, alpha-carotene, beta-carotene, beta-caraotene, beta-apo-carotenoic acid, carnosol, carvacrol, catechins, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-Ethox®y-1,2-dihydro-2,2,4-trimethylquinoline, ethyl gallate, ethyl maltol, ethylenediaminetetraacetic acid (EDTA), Eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, rice bran extract, lactic acid and its salts, lecithin, lecithin citrate; R-alpha-lipoic acid, lutein, lycopene, malic acid, maltol, 5-mEthox®y tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rosemary extract, rosmarinic acid, SAG™e extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof.

In some embodiments, the preservative may be an isothiazolinone-based preservative. Isothiazolinones may be particularly suitable for use in aqueous pesticidal suspension compositions due to their broad-spectrum antimicrobial activity against bacteria, yeasts, and fungi. The isothiazolinone-based preservative may be included to protect the composition from microbial contamination during manufacture, storage, and use, thereby helping to maintain formulation stability and performance. Non-limiting examples of isothiazolinones include 1,2-benzisothiazolin-3-one and mixtures thereof, as well as commercially available isothiazolinone-containing preservatives, such as Proxel® GXL. The isothiazolinone-based preservative may be present in an amount effective to inhibit microbial growth without adversely affecting the pesticidal activity or physical properties of the composition.

### Chelating Agents

A chelating agent may optionally be included as an excipient to immobilize oxidative groups, including but not limited to metal ions, in order to inhibit the oxidative degradation of the morphinan by these oxidative groups. Non-limiting examples of chelating agents include lysine, methionine, glycine, gluconate, polysaccharides, glutamate, aspartate, and disodium ethylenediaminetetraacetate (Na2EDTA).

### Antimicrobial Agents

An antimicrobial agent may optionally be included as an excipient to minimize the degradation of the compound according to this disclosure by microbial agents, including but not limited to, bacteria and fungi. Non-limiting examples of antimicrobials include parabens, chlorobutanol, phenol, calcium propionate, sodium nitrate, sodium nitrite, Na2EDTA, and sulfites including but not limited to sulfur dioxide, sodium bisulfite, and potassium hydrogen sulfite.

### Coloring Agents

Coloring agents may optionally be included in the composition. Suitable color additives include, but are not limited to, food, drug and cosmetic colors (FD&C), drug and cosmetic colors (D&C), external drug and cosmetic colors (Ext. D&C), or fluorescent dyes.

### Attractant

The term “attractant,” as employed herein, refers to any substance which a pest will find appealing as a food item such that it will tend to transport it back to the nest, and expressly includes foods, baits, attractants and feeding stimulants, as well as combinations thereof.

Suitable ingredients may be an ingredient perceived as a food by the pest. The food attractant can and will vary depending on the pest, the method of using the composition, and the intended use of the composition. For instance, when the pest is a termite, non-limiting examples of a food attractant may be brown rot derivatives, scorched cellulosic material, edible fungus derivatives, and long-chain fatty acids. When the pest is a roach, non-limiting examples of a food attractant may be brewer's yeast, corn grit, sugar, gelatin, powdered organ meats, powdered cheese, brown rot derivatives, scorched cellulosic material, edible fungus derivatives, and long-chain fatty acids.

Alternatively, the attractant may be a non-edible attractant. For instance, a suitable attractant may be semiochemicals that mimic pest attraction systems found in nature. Non-limiting examples of semiochemicals include pheromones, plant volatiles, flower oils, sugars, and proteins.

### Specific Compositions

The following formulations are illustrative, non-limiting examples of suspension embodiments. In certain embodiments, a stable indoxacarb suspension is achieved using the core components of indoxacarb, a dispersant, a surfactant, and water; additional formulation ingredients (e.g., thickeners, antifreeze agents, preservatives, and antifoaming agents) may be included to enhance handling, freeze-thaw performance, microbial resistance, or processing characteristics, but are optional and not required in all embodiments.

In certain embodiments, the pesticidal suspension composition is a suspension comprising about 5% w/w to about 10% w/w solid particulate indoxacarb; about 1% w/w to about 3% w/w of one or more anionic surfactants; water; and optionally one or more of an antifoaming agent, propylene glycol, xanthan powder, and preservatives.

In certain embodiments, the pesticidal suspension composition is a suspension comprising about 15% w/w to about 30% w/w solid particulate indoxacarb; about 3.0% w/w to about 6.0% w/w dispersant; about 1% w/w to about 2.0% w/w non-ionic surfactant; water; and optionally one or more of about xanthan powder, preservative, propylene glycol, and antifoaming agent.

In certain embodiments, the pesticidal suspension composition is an aqueous suspension comprising about 5% w/w to about 10% w/w solid particulate indoxacarb and one or more additional active ingredients, such as about 1% w/w to about 2% w/w of a pyridine-based pesticide (e.g., Pyriproxyfen Tech) and about 1% w/w to about 2% w/w of novaluron. The composition may further comprise about 1% w/w to about 3% w/w of one or more anionic surfactants (e.g., Aerosol® OT-75, Soprophor® FLK) and may optionally include formulation aids such as an antifoaming agent (e.g., Agnique® DFM111S) in an amount of about 0.1% w/w to about 0.8% w/w, propylene glycol in an amount of about 3% w/w to about 5% w/w, a thickener such as xanthan powder (e.g., Ticaxan® pre-hydrated xanthan) in an amount of about 0.1% w/w to about 0.5% w/w, and a preservative (e.g., Proxel® GXL) in an amount of about 0.1% w/w to about 0.5% w/w, with the balance comprising water (e.g., about 80% w/w to about 90% w/w).

In certain embodiments, the pesticidal suspension composition is an aqueous suspension comprising about 5% w/w to about 10% w/w solid particulate indoxacarb and about 5% w/w to about 10% w/w solid particulate imidacloprid. The composition may further comprise a dispersant (e.g., Atlox™ 4913) in an amount of about 0.1% w/w to about 1.0% w/w and one or more surfactants, such as a non-ionic surfactant (e.g., Step-Flow® 26F) in an amount of about 3% w/w to about 10% w/w and, optionally, an additional surfactant (e.g., Soprophor® FLK) in an amount of about 0.1% w/w to about 1.0% w/w. The composition may optionally include formulation aids such as a thickener (e.g., xanthan powder, Ticaxan® pre-hydrated xanthan) in an amount of about 0.1% w/w to about 0.5% w/w, a preservative (e.g., Proxel® GXL) in an amount of about 0.1% w/w to about 0.5% w/w, an antifoaming agent (e.g., SAG™ 30) in an amount of about 0.5% w/w to about 1.5% w/w, and propylene glycol in an amount of about 5% w/w to about 15% w/w, with the balance comprising water (e.g., about 60% w/w to about 70% w/w).

### Pesticidal Suspension Concentrate

In one aspect, the disclosure provides a pesticidal suspension concentrate in which the formulation is built around the core components of indoxacarb, a dispersant, and a surfactant. In such embodiments, indoxacarb is present as a high-active-content, particulate phase in an aqueous medium, and the dispersant and surfactant are present in amounts effective to wet, disperse, and stabilize the indoxacarb particles such that the concentrate remains a stable suspension during storage and may be readily re-dispersed upon agitation. The suspension concentrate is suitable for subsequent dilution with water prior to application.

The dispersant may be selected from any dispersants described herein, including polymeric dispersants, lignosulfonates, naphthalene sulfonate condensates, polycarboxylates, or combinations thereof. The surfactant may be selected from any of the surfactants described herein, including non-ionic, anionic, cationic, amphoteric surfactants, or combinations thereof.

In some embodiments, the suspension concentrate is an aqueous suspension concentrate that includes indoxacarb particles, one or more dispersants, and one or more surfactants in water, and does not require additional formulation excipients to achieve storage stability. In such embodiments, the suspension concentrate may consist of, or consist essentially of, indoxacarb, the dispersant(s), the surfactant(s), and water (apart from incidental impurities or optional pH adjusters), wherein the dispersant(s) and surfactant(s) are present in amounts effective to wet, disperse, and stabilize the indoxacarb particles so that the concentrate remains a stable suspension during storage and may be readily re-dispersed upon agitation. Accordingly, additional components, such as a thickener, preservative, antifreeze agent, and antifoaming agent, are optional and may be omitted.

The indoxacarb may be present in an amount of about 45% to about 55% by weight of the suspension concentrate. For example, the indoxacarb may be present in an amount of about 45.1% to about 54.9%, about 45.2% to about 54.8%, about 45.3% to about 54.7%, about 45.4% to about 54.6%, about 45.5% to about 54.5%, about 45.6% to about 54.4%, about 45.7% to about 54.3%, about 45.8% to about 54.2%, about 45.9% to about 54.1%, about 46.0% to about 54.0%, about 46.1% to about 53.9%, about 46.2% to about 53.8%, about 46.3% to about 53.7%, about 46.4% to about 53.6%, about 46.5% to about 53.5%, about 46.6% to about 53.4%, about 46.7% to about 53.3%, about 46.8% to about 53.2%, about 46.9% to about 53.1%, about 47.0% to about 53.0%, about 47.1% to about 52.9%, about 47.2% to about 52.8%, about 47.3% to about 52.7%, about 47.4% to about 52.6%, about 47.5% to about 52.5%, about 47.6% to about 52.4%, about 47.7% to about 52.3%, about 47.8% to about 52.2%, about 47.9% to about 52.1%, about 48.0% to about 52.0%, about 48.1% to about 51.9%, about 48.2% to about 51.8%, about 48.3% to about 51.7%, about 48.4% to about 51.6%, about 48.5% to about 51.5%, about 48.6% to about 51.4%, about 48.7% to about 51.3%, about 48.8% to about 51.2%, about 48.9% to about 51.1%, about 49.0% to about 51.0%, about 49.1% to about 50.9%, about 49.2% to about 50.8%, about 49.3% to about 50.7%, about 49.4% to about 50.6%, about 49.5% to about 50.5%, about 49.6% to about 50.4%, about 49.7% to about 50.3%, about 49.8% to about 50.2%, or about 49.9% to about 50.1% by weight of the suspension concentrate.

The dispersant may be present in an amount of about 10% to about 12% by weight of the suspension concentrate. For example, the dispersant may be present in an amount of about 10.1% to about 11.9%, about 10.2% to about 11.8%, about 10.3% to about 11.7%, about 10.4% to about 11.6%, about 10.5% to about 11.5%, about 10.6% to about 11.4%, about 10.7% to about 11.3%, about 10.8% to about 11.2%, or about 10.9% to about 11.1% by weight of the suspension concentrate.

The surfactant may be present in an amount of about 2% to about 5% by weight of the suspension concentrate. For example, the surfactant may be present in an amount of about 2.1% to about 4.9%, about 2.2% to about 4.8%, about 2.3% to about 4.7%, about 2.4% to about 4.6%, about 2.5% to about 4.5%, about 2.6% to about 4.4%, about 2.7% to about 4.3%, about 2.8% to about 4.2%, about 2.9% to about 4.1%, about 3.0% to about 4.0%, about 3.1% to about 3.9%, about 3.2% to about 3.8%, about 3.3% to about 3.7%, or about 3.4% to about 3.6% by weight of the suspension concentrate.

In some embodiments of the suspension concentrate, the weight ratio of dispersant to surfactant is selected to maintain the indoxacarb as a stable suspension during storage and to facilitate re-dispersion upon agitation. In some embodiments of the suspension concentrate, the weight ratio of dispersant to surfactant may be about 2:1 to about 6:1. For example, the weight ratio of dispersant to surfactant may be about 2.1:1 to about 5.9:1, about 2.2:1 to about 5.8:1, about 2.3:1 to about 5.7:1, about 2.4:1 to about 5.6:1, about 2.5:1 to about 5.5:1, about 2.6:1 to about 5.4:1, about 2.7:1 to about 5.3:1, about 2.8:1 to about 5.2:1, about 2.9:1 to about 5.1:1, about 3.0:1 to about 5.0:1, about 3.1:1 to about 4.9:1, about 3.2:1 to about 4.8:1, about 3.3:1 to about 4.7:1, about 3.4:1 to about 4.6:1, about 3.5:1 to about 4.5:1, about 3.6:1 to about 4.4:1, about 3.7:1 to about 4.3:1, about 3.8:1 to about 4.2:1, about 3.9:1 to about 4.1:1, or about 4.0:1 to about 4.0:1.

In certain embodiments, the suspension concentrate consists essentially of about 45% to about 50% by weight indoxacarb, about 10% to about 12% by weight of a dispersant, and about 2% to about 5% by weight of a surfactant, based on the total weight of the suspension concentrate.

In some embodiments, the suspension concentrate further comprises one or more optional formulation additives. For example, the suspension concentrate may include an antifreeze agent, an antifoaming agent, a preservative, a thickener, or any combination thereof. Such optional components may be included to improve storage stability, handling characteristics, freeze-thaw resistance, microbial resistance, or processing performance of the suspension concentrate.

In some embodiments, the suspension concentrate optionally comprises an antifreeze agent. When present, the antifreeze agent may be included in an amount effective to improve low-temperature stability and reduce or prevent freezing during storage or transportation. The antifreeze agent, when present, may comprise propylene glycol, ethylene glycol, glycerol, or combinations thereof, and may be included in an amount effective to improve low-temperature stability. In certain embodiments, the antifreeze agent may be present in an amount of about 20% to about 40% by weight of the suspension concentrate. For example, the antifreeze agent may be present in an amount of about 20.1% to about 39.9%, about 20.2% to about 39.8%, about 20.3% to about 39.7%, about 20.4% to about 39.6%, about 20.5% to about 39.5%, about 20.6% to about 39.4%, about 20.7% to about 39.3%, about 20.8% to about 39.2%, about 20.9% to about 39.1%, about 21.0% to about 39.0%, about 21.1% to about 38.9%, about 21.2% to about 38.8%, about 21.3% to about 38.7%, about 21.4% to about 38.6%, about 21.5% to about 38.5%, about 22.0% to about 38.0%, about 22.5% to about 37.5%, about 23.0% to about 37.0%, about 23.5% to about 36.5%, about 24.0% to about 36.0%, about 24.5% to about 35.5%, about 25.0% to about 35.0%, about 25.5% to about 34.5%, about 26.0% to about 34.0%, about 26.5% to about 33.5%, about 27.0% to about 33.0%, about 27.5% to about 32.5%, about 28.0% to about 32.0%, about 28.5% to about 31.5%, about 29.0% to about 31.0%, or about 29.5% to about 30.5% by weight of the suspension concentrate.

In some embodiments, the suspension concentrate optionally comprises an antifoaming agent. When present, the antifoaming agent may be included in an amount effective to reduce or suppress foam formation during manufacture, mixing, dilution, or application of the suspension concentrate. The antifoaming agent, when present, may comprise a silicone-based antifoam. In certain embodiments, the antifoaming agent may be present in an amount of about 1% to about 6% by weight of the suspension concentrate. For example, the antifoaming agent may be present in an amount of about 1.1% to about 5.9%, about 1.2% to about 5.8%, about 1.3% to about 5.7%, about 1.4% to about 5.6%, about 1.5% to about 5.5%, about 1.6% to about 5.4%, about 1.7% to about 5.3%, about 1.8% to about 5.2%, about 1.9% to about 5.1%, about 2.0% to about 5.0%, about 2.1% to about 4.9%, about 2.2% to about 4.8%, about 2.3% to about 4.7%, about 2.4% to about 4.6%, about 2.5% to about 4.5%, about 2.6% to about 4.4%, about 2.7% to about 4.3%, about 2.8% to about 4.2%, about 2.9% to about 4.1%, about 3.0% to about 4.0%, about 3.1% to about 3.9%, about 3.2% to about 3.8%, about 3.3% to about 3.7%, or about 3.4% to about 3.6% by weight of the suspension concentrate.

In some embodiments, the suspension concentrate optionally comprises a preservative. When present, the preservative may comprise an antimicrobial or biocidal preservative effective to inhibit microbial growth during storage. In certain embodiments, the preservative may be present in an amount of about 0.2% to about 2.0% by weight of the suspension concentrate. For example, the preservative may be present in an amount of about 0.21% to about 1.99%, about 0.22% to about 1.98%, about 0.23% to about 1.97%, about 0.24% to about 1.96%, about 0.25% to about 1.95%, about 0.30% to about 1.90%, about 0.35% to about 1.85%, about 0.40% to about 1.80%, about 0.45% to about 1.75%, about 0.50% to about 1.70%, about 0.55% to about 1.65%, about 0.60% to about 1.60%, about 0.65% to about 1.55%, about 0.70% to about 1.50%, about 0.75% to about 1.45%, about 0.80% to about 1.40%, about 0.85% to about 1.35%, about 0.90% to about 1.30%, about 0.95% to about 1.25%, or about 1.00% to about 1.20% by weight of the suspension concentrate.

In some embodiments, the suspension concentrate optionally comprises a thickener. When present, the thickener may comprise a polysaccharide, cellulose derivative, clay, or synthetic polymer effective to enhance suspension stability, for example by increasing viscosity and/or reducing settling during storage. In certain embodiments, the thickener may be present in an amount of about 0.1% to about 1.5% by weight of the suspension concentrate. For example, the thickener may be present in an amount of about 0.11% to about 1.49%, about 0.12% to about 1.48%, about 0.13% to about 1.47%, about 0.14% to about 1.46%, about 0.15% to about 1.45%, about 0.20% to about 1.40%, about 0.25% to about 1.35%, about 0.30% to about 1.30%, about 0.35% to about 1.25%, about 0.40% to about 1.20%, about 0.45% to about 1.15%, about 0.50% to about 1.10%, about 0.55% to about 1.05%, about 0.60% to about 1.00%, about 0.65% to about 0.95%, about 0.70% to about 0.90%, or about 0.75% to about 0.85% by weight of the suspension concentrate.

It will be understood that the suspension concentrate compositions described herein may be diluted with water prior to application to form a sprayable suspension. The relative amounts of indoxacarb, dispersant, and surfactant may be selected and adjusted within the disclosed ranges to maintain a physically stable and effective suspension concentrate, and any optional additives, when present, may likewise be adjusted or omitted without departing from the scope of the disclosure.

### Pesticidal Suspension Composition

The pesticidal suspension concentrate may be dispersed in water prior to use to form a sprayable pesticidal suspension composition comprising indoxacarb, a dispersant, a surfactant, and water. The dispersant and surfactant may be present in amounts effective to wet, disperse, and stabilize the indoxacarb particles, thereby maintaining the composition as a stable suspension during storage.

In certain embodiments, the pesticidal suspension composition consists essentially of indoxacarb, one or more dispersants, one or more surfactants, and water, wherein the dispersant(s) and surfactant(s) are present in amounts effective to wet, disperse, and stabilize the indoxacarb particles to maintain a stable suspension during storage. Optional components, including thickeners, preservatives, antifreeze agents, and antifoaming agents, may be included to enhance handling and storage characteristics, but are not required to maintain indoxacarb as a stable suspension during storage.

Indoxacarb is present as the active pesticidal ingredient and may be provided in technical grade form and/or as finely divided particles suitable for formulation as a suspension. Indoxacarb may be present in an amount of about 5% to about 30% by weight of the total pesticidal suspension composition. For example, indoxacarb may be present in an amount of about 5.1% to about 29.9%, about 5.2% to about 29.8%, about 5.3% to about 29.7%, about 5.4% to about 29.6%, about 5.5% to about 29.5%, about 5.6% to about 29.4%, about 5.7% to about 29.3%, about 5.8% to about 29.2%, about 5.9% to about 29.1%, about 6.0% to about 29.0%, about 6.1% to about 28.9%, about 6.2% to about 28.8%, about 6.3% to about 28.7%, about 6.4% to about 28.6%, about 6.5% to about 28.5%, about 6.6% to about 28.4%, about 6.7% to about 28.3%, about 6.8% to about 28.2%, about 6.9% to about 28.1%, about 7.0% to about 28.0%, about 7.1% to about 27.9%, about 7.2% to about 27.8%, about 7.3% to about 27.7%, about 7.4% to about 27.6%, about 7.5% to about 27.5%, about 7.6% to about 27.4%, about 7.7% to about 27.3%, about 7.8% to about 27.2%, about 7.9% to about 27.1%, about 8.0% to about 27.0%, about 8.1% to about 26.9%, about 8.2% to about 26.8%, about 8.3% to about 26.7%, about 8.4% to about 26.6%, about 8.5% to about 26.5%, about 8.6% to about 26.4%, about 8.7% to about 26.3%, about 8.8% to about 26.2%, about 8.9% to about 26.1%, about 9.0% to about 26.0%, about 9.1% to about 25.9%, about 9.2% to about 25.8%, about 9.3% to about 25.7%, about 9.4% to about 25.6%, about 9.5% to about 25.5%, about 9.6% to about 25.4%, about 9.7% to about 25.3%, about 9.8% to about 25.2%, about 9.9% to about 25.1%, or about 10.0% to about 25.0% by weight of the total suspension composition. In other examples, indoxacarb may be present in an amount of about 10.1% to about 24.9%, about 10.2% to about 24.8%, about 10.3% to about 24.7%, about 10.4% to about 24.6%, about 10.5% to about 24.5%, about 10.6% to about 24.4%, about 10.7% to about 24.3%, about 10.8% to about 24.2%, about 10.9% to about 24.1%, about 11.0% to about 24.0%, about 11.1% to about 23.9%, about 11.2% to about 23.8%, about 11.3% to about 23.7%, about 11.4% to about 23.6%, about 11.5% to about 23.5%, about 11.6% to about 23.4%, about 11.7% to about 23.3%, about 11.8% to about 23.2%, about 11.9% to about 23.1%, about 12.0% to about 23.0%, about 12.1% to about 22.9%, about 12.2% to about 22.8%, about 12.3% to about 22.7%, about 12.4% to about 22.6%, about 12.5% to about 22.5%, about 12.6% to about 22.4%, about 12.7% to about 22.3%, about 12.8% to about 22.2%, about 12.9% to about 22.1%, about 13.0% to about 22.0%, about 13.1% to about 21.9%, about 13.2% to about 21.8%, about 13.3% to about 21.7%, about 13.4% to about 21.6%, about 13.5% to about 21.5%, about 13.6% to about 21.4%, about 13.7% to about 21.3%, about 13.8% to about 21.2%, about 13.9% to about 21.1%, about 14.0% to about 21.0%, about 14.1% to about 20.9%, about 14.2% to about 20.8%, about 14.3% to about 20.7%, about 14.4% to about 20.6%, about 14.5% to about 20.5%, about 14.6% to about 20.4%, about 14.7% to about 20.3%, about 14.8% to about 20.2%, about 14.9% to about 20.1%, or about 15.0% to about 20.0% by weight of the total suspension composition. In other examples, indoxacarb may be present in an amount of about 15.1% to about 19.9%, about 15.2% to about 19.8%, about 15.3% to about 19.7%, about 15.4% to about 19.6%, about 15.5% to about 19.5%, about 15.6% to about 19.4%, about 15.7% to about 19.3%, about 15.8% to about 19.2%, about 15.9% to about 19.1%, about 16.0% to about 19.0%, about 16.1% to about 18.9%, about 16.2% to about 18.8%, about 16.3% to about 18.7%, about 16.4% to about 18.6%, about 16.5% to about 18.5%, about 16.6% to about 18.4%, about 16.7% to about 18.3%, about 16.8% to about 18.2%, about 16.9% to about 18.1%, about 17.0% to about 18.0%, about 17.1% to about 17.9%, about 17.2% to about 17.8%, about 17.3% to about 17.7%, or about 17.4% to about 17.6% weight of the total pesticidal suspension composition.

In particular embodiments, indoxacarb is present in an amount of about 20% to about 25% by weight of the pesticidal suspension composition. The indoxacarb amount may be about 20.1%, about 20.2%, about 20.3%, about 20.4%, about 20.5%, about 20.6%, about 20.7%, about 20.8%, about 20.9%, about 21.0%, about 21.1%, about 21.2%, about 21.3%, about 21.4%, about 21.5%, about 21.6%, about 21.7%, about 21.8%, about 21.9%, about 22.0%, about 22.1%, about 22.2%, about 22.3%, about 22.4%, about 22.5%, about 22.6%, about 22.7%, about 22.8%, about 22.9%, about 23.0%, about 23.1%, about 23.2%, about 23.3%, about 23.4%, about 23.5%, about 23.6%, about 23.7%, about 23.8%, about 23.9%, about 24.0%, about 24.1%, about 24.2%, about 24.3%, about 24.4%, about 24.5%, about 24.6%, about 24.7%, about 24.8%, about 24.9%, or about 25.0% by weight of the total pesticidal suspension composition.

One or more dispersants may be present in an amount of about 4% to about 10% by weight of the total pesticidal suspension composition. For example, the dispersant(s) may be present in an amount of about 4.1% to about 9.9%, about 4.2% to about 9.8%, about 4.3% to about 9.7%, about 4.4% to about 9.6%, about 4.5% to about 9.5%, about 4.6% to about 9.4%, about 4.7% to about 9.3%, about 4.8% to about 9.2%, about 4.9% to about 9.1%, about 5.0% to about 9.0%, about 5.1% to about 8.9%, about 5.2% to about 8.8%, about 5.3% to about 8.7%, about 5.4% to about 8.6%, about 5.5% to about 8.5%, about 5.6% to about 8.4%, about 5.7% to about 8.3%, about 5.8% to about 8.2%, about 5.9% to about 8.1%, about 6.0% to about 8.0%, about 6.1% to about 7.9%, about 6.2% to about 7.8%, about 6.3% to about 7.7%, about 6.4% to about 7.6%, about 6.5% to about 7.5%, about 6.6% to about 7.4%, about 6.7% to about 7.3%, about 6.8% to about 7.2%, about 6.9% to about 7.1%, or about 7.0% to about 7.0% by weight of the total suspension composition. In some examples, the dispersant(s) may be present in an amount of about 4.5% to about 6%, about 4.6% to about 5.9%, about 4.7% to about 5.8%, about 4.8% to about 5.7%, about 4.9% to about 5.6%, about 5.0% to about 5.5%, about 5.1% to about 5.4%, or about 5.2% to about 5.3% by weight of the total pesticidal suspension composition.

One or more surfactants may be present in an amount of about 0.5% to about 5% by weight of the total pesticidal suspension composition. For example, the surfactant(s) may be present in an amount of about 0.6% to about 4.9%, about 0.7% to about 4.8%, about 0.8% to about 4.7%, about 0.9% to about 4.6%, about 1.0% to about 4.5%, about 1.1% to about 4.4%, about 1.2% to about 40.3%, about 1.3% to about 4.2%, about 1.4% to about 4.1%, about 1.5% to about 4.0%, about 1.6% to about 3.9%, about 1.7% to about 3.8%, about 1.8% to about 3.7%, about 1.9% to about 3.6%, about 2.0% to about 30.5%, about 2.1% to about 3.4%, about 2.2% to about 30.3%, about 20.3% to about 3.2%, about 2.4% to about 3.1%, about 20.5% to about 3.0%, about 2.6% to about 2.9%, about 2.7% to about 2.8%, or about 2.8% to about 2.7% by weight of the total suspension composition. In other examples, the surfactant(s) may be present in an amount of about 1% to about 2%, about 1.1% to about 1.9%, about 1.2% to about 1.8%, about 1.3% to about 1.7%, about 1.4% to about 1.6%, or about 1.5% to about 1.5% by weight of the total suspension composition. In some examples, the surfactant(s) may be present in an amount of about 1.0% to about 2.0%, about 1.10% to about 1.9%, about 1.2% to about 1.8%, about 1.3% to about 1.7%, or about 1.4% to about 1.6% by weight of the total pesticidal suspension composition.

In some embodiments of the pesticidal suspension composition, the weight ratio of dispersant(s) to surfactant(s) is selected to maintain the indoxacarb as a stable suspension during storage and to facilitate re-dispersion upon agitation. In some embodiments of the pesticidal suspension composition, the weight ratio of dispersant(s) to surfactant(s) may be about 2:1 to about 6:1. For example, the weight ratio of dispersant to surfactant may be about 2.1:1 to about 5.9:1, about 2.2:1 to about 5.8:1, about 2.3:1 to about 5.7:1, about 2.4:1 to about 5.6:1, about 2.5:1 to about 5.5:1, about 2.6:1 to about 5.4:1, about 2.7:1 to about 5.3:1, about 2.8:1 to about 5.2:1, about 2.9:1 to about 5.1:1, about 3.0:1 to about 5.0:1, about 3.1:1 to about 4.9:1, about 3.2:1 to about 4.8:1, about 3.3:1 to about 4.7:1, about 3.4:1 to about 4.6:1, about 3.5:1 to about 4.5:1, about 3.6:1 to about 4.4:1, about 3.7:1 to about 4.3:1, about 3.8:1 to about 4.2:1, about 3.9:1 to about 4.1:1, or about 4.0:1 to about 4.0:1.

In some embodiments, the dispersant(s) are present in an amount of about 4.5% to about 6%, and the surfactant(s) are present in an amount of about 1% to about 2% by weight of the total suspension composition. In such embodiments, selection and relative amounts of the dispersant(s) and surfactant(s) may be important for achieving and maintaining suspension stability during storage.

In some embodiments, the pesticidal suspension composition optionally further comprises a thickener. When present, the thickener may be included in an amount effective to modify the rheology (e.g., increase viscosity and/or reduce settling) and thereby enhance handling and/or storage characteristics of the suspension. Suitable thickeners include xanthan gum, cellulose derivatives, polysaccharides, clays, synthetic polymers, and any combination thereof. In certain embodiments, the thickener may be present in an amount of about 0.05% to about 1.0% by weight of the total pesticidal suspension composition. For example, the thickener may be present in an amount of about 0.06% to about 0.99%, about 0.07% to about 0.98%, about 0.08% to about 0.97%, about 0.09% to about 0.96%, about 0.10% to about 0.95%, about 0.11% to about 0.94%, about 0.12% to about 0.93%, about 0.13% to about 0.92%, about 0.14% to about 0.91%, about 0.15% to about 0.90%, about 0.16% to about 0.89%, about 0.17% to about 0.88%, about 0.18% to about 0.87%, about 0.19% to about 0.86%, about 0.20% to about 0.85%, about 0.21% to about 0.84%, about 0.22% to about 0.83%, about 0.23% to about 0.82%, about 0.24% to about 0.81%, about 0.25% to about 0.80%, about 0.26% to about 0.79%, about 0.27% to about 0.78%, about 0.28% to about 0.77%, about 0.29% to about 0.76%, about 0.30% to about 0.75%, about 0.31% to about 0.74%, about 0.32% to about 0.73%, about 0.33% to about 0.72%, about 0.34% to about 0.71%, about 0.35% to about 0.70%, about 0.36% to about 0.69%, about 0.37% to about 0.68%, about 0.38% to about 0.67%, about 0.39% to about 0.66%, about 0.40% to about 0.65%, about 0.41% to about 0.64%, about 0.42% to about 0.63%, about 0.43% to about 0.62%, about 0.44% to about 0.61%, about 0.45% to about 0.60%, about 0.46% to about 0.59%, about 0.47% to about 0.58%, about 0.48% to about 0.57%, about 0.49% to about 0.56%, about 0.50% to about 0.55%, or about 0.51% to about 0.54% by weight of the total pesticidal suspension composition. In certain embodiments, the thickener may be present in an amount of about 0.1% to about 0.5% by weight of the total suspension composition. For example, the thickener may be present in an amount of about 0.11% to about 0.49%, about 0.12% to about 0.48%, about 0.13% to about 0.47%, about 0.14% to about 0.46%, about 0.15% to about 0.45%, about 0.16% to about 0.44%, about 0.17% to about 0.43%, about 0.18% to about 0.42%, about 0.19% to about 0.41%, about 0.20% to about 0.40%, about 0.21% to about 0.39%, about 0.22% to about 0.38%, about 0.23% to about 0.37%, about 0.24% to about 0.36%, or about 0.25% to about 0.25% by weight of the total suspension composition.

In some embodiments, the pesticidal suspension composition optionally further comprises a preservative. When present, the preservative may be selected to inhibit or reduce microbial growth and thereby maintain the microbiological stability of the composition during storage. Suitable preservatives include Proxel® GXL, parabens, and combinations thereof. In certain embodiments, the preservative may be present in an amount of about 0.05% to about 1.0% by weight of the total pesticidal suspension composition. For example, the preservative may be present in an amount of about 0.06% to about 0.99%, about 0.07% to about 0.98%, about 0.08% to about 0.97%, about 0.09% to about 0.96%, about 0.10% to about 0.95%, about 0.11% to about 0.94%, about 0.12% to about 0.93%, about 0.13% to about 0.92%, about 0.14% to about 0.91%, about 0.15% to about 0.90%, about 0.16% to about 0.89%, about 0.17% to about 0.88%, about 0.18% to about 0.87%, about 0.19% to about 0.86%, about 0.20% to about 0.85%, about 0.21% to about 0.84%, about 0.22% to about 0.83%, about 0.23% to about 0.82%, about 0.24% to about 0.81%, about 0.25% to about 0.80%, about 0.26% to about 0.79%, about 0.27% to about 0.78%, about 0.28% to about 0.77%, about 0.29% to about 0.76%, about 0.30% to about 0.75%, about 0.31% to about 0.74%, about 0.32% to about 0.73%, about 0.33% to about 0.72%, about 0.34% to about 0.71%, about 0.35% to about 0.70%, about 0.36% to about 0.69%, about 0.37% to about 0.68%, about 0.38% to about 0.67%, about 0.39% to about 0.66%, about 0.40% to about 0.65%, about 0.41% to about 0.64%, about 0.42% to about 0.63%, about 0.43% to about 0.62%, about 0.44% to about 0.61%, about 0.45% to about 0.60%, about 0.46% to about 0.59%, about 0.47% to about 0.58%, about 0.48% to about 0.57%, about 0.49% to about 0.56%, about 0.50% to about 0.55%, or about 0.51% to about 0.54% by weight of the total pesticidal suspension composition. In certain embodiments, the preservative may be present in an amount of about 0.1% to about 0.6% by weight of the total suspension composition. For example, the preservative may be present in an amount of about 0.11% to about 0.59%, about 0.12% to about 0.58%, about 0.13% to about 0.57%, about 0.14% to about 0.56%, about 0.15% to about 0.55%, about 0.16% to about 0.54%, about 0.17% to about 0.53%, about 0.18% to about 0.52%, about 0.19% to about 0.51%, about 0.20% to about 0.50%, about 0.21% to about 0.49%, about 0.22% to about 0.48%, about 0.23% to about 0.47%, about 0.24% to about 0.46%, about 0.25% to about 0.45%, about 0.26% to about 0.44%, about 0.27% to about 0.43%, about 0.28% to about 0.42%, about 0.29% to about 0.41%, about 0.30% to about 0.40%, about 0.31% to about 0.39%, about 0.32% to about 0.38%, about 0.33% to about 0.37%, about 0.34% to about 0.36%, or about 0.35% to about 0.35% by weight of the total pesticidal suspension composition.

In some embodiments, the pesticidal suspension composition optionally further comprises an antifreeze agent. When present, the antifreeze agent may comprise propylene glycol, ethylene glycol, glycerol, or combinations thereof, and may be included to improve low-temperature stability and reduce or prevent freezing during storage or transportation. In certain embodiments, the antifreeze agent may also function as a humectant and/or co-solvent, contributing to handling characteristics without being required for suspension stability. The specific amount of antifreeze agent, when included, may be selected based on the desired freeze-thaw stability, anticipated storage conditions, and compatibility with other formulation components, provided that the antifreeze agent does not adversely affect the pesticidal efficacy or suspension stability. In certain embodiments, the antifreeze agent may be present in an amount of about 10% to about 15% by weight of the total pesticidal suspension composition. For example, the antifreeze agent may be present in an amount of about 10.1% to about 14.9%, about 10.2% to about 14.8%, about 10.3% to about 14.7%, about 10.4% to about 14.6%, about 10.5% to about 14.5%, about 10.6% to about 14.4%, about 10.7% to about 14.3%, about 10.8% to about 14.2%, about 10.9% to about 14.1%, about 11.0% to about 14.0%, about 11.1% to about 13.9%, about 11.2% to about 13.8%, about 11.3% to about 13.7%, about 11.4% to about 13.6%, about 11.5% to about 13.5%, about 11.6% to about 13.4%, about 11.7% to about 13.3%, about 11.8% to about 13.2%, about 11.9% to about 13.1%, about 12.0% to about 13.0%, about 12.1% to about 12.9%, about 12.2% to about 12.8%, about 12.3% to about 12.7%, or about 12.4% to about 12.6% by weight of the total pesticidal suspension composition. In certain embodiments, the antifreeze agent may be present in an amount of up to about 25 wt % of the total suspension composition.

In some embodiments, the pesticidal suspension composition optionally further comprises an antifoaming agent. When present, the antifoaming agent may be selected to reduce or suppress foam formation during manufacture, mixing, dilution, or application. In certain embodiments, the antifoaming agent comprises a silicone-based antifoam, which may be effective at low concentrations and compatible with a wide range of aqueous formulations. The antifoaming agent, when included, may be present in an amount sufficient to control foam formation without adversely affecting the physical stability or pesticidal performance of the composition. In certain embodiments, the antifoaming agent may be present in an amount of about 0.1% to about 5.0% by weight of the total pesticidal suspension composition. For example, the antifoaming agent may be present in an amount of about 0.2% to about 4.9%, about 0.3% to about 4.8%, about 0.4% to about 4.7%, about 0.5% to about 4.6%, about 0.6% to about 4.5%, about 0.7% to about 4.4%, about 0.8% to about 4.3%, about 0.9% to about 4.2%, about 1.0% to about 4.1%, about 1.1% to about 4.0%, about 1.2% to about 3.9%, about 1.3% to about 3.8%, about 1.4% to about 3.7%, about 1.5% to about 3.6%, about 1.6% to about 3.5%, about 1.7% to about 3.4%, about 1.8% to about 3.3%, about 1.9% to about 3.2%, about 2.0% to about 3.1%, about 2.1% to about 3.0%, about 2.2% to about 2.9%, about 2.3% to about 2.8%, or about 2.4% to about 2.7% by weight of the total pesticidal suspension composition. In certain embodiments, the antifoaming agent may be present in an amount of about 0.5% to about 2.5% by weight of the total pesticidal suspension composition. For example, the antifoaming agent may be present in an amount of about 0.6% to about 2.4%, about 0.7% to about 2.3%, about 0.8% to about 2.2%, about 0.9% to about 2.1%, about 1.0% to about 2.0%, about 1.1% to about 1.9%, about 1.2% to about 1.8%, about 1.3% to about 1.7%, or about 1.4% to about 1.6% by weight of the total pesticidal suspension composition.

In some embodiments, water may be present in an amount of about 50% to about 89.5% by weight of the total pesticidal suspension composition. For example, water may be present in an amount of about 50.1% to about 89.4%, about 50.2% to about 89.3%, about 50.3% to about 89.2%, about 50.4% to about 89.1%, about 50.5% to about 89.0%, about 50.6% to about 88.9%, about 50.7% to about 88.8%, about 50.8% to about 88.7%, about 50.9% to about 88.6%, about 51.0% to about 88.5%, about 51.1% to about 88.4%, about 51.2% to about 88.3%, about 51.3% to about 88.2%, about 51.4% to about 88.1%, about 51.5% to about 88.0%, about 51.6% to about 87.9%, about 51.7% to about 87.8%, about 51.8% to about 87.7%, about 51.9% to about 87.6%, about 52.0% to about 87.5%, about 52.1% to about 87.4%, about 52.2% to about 87.3%, about 52.3% to about 87.2%, about 52.4% to about 87.1%, about 52.5% to about 87.0%, about 52.6% to about 86.9%, about 52.7% to about 86.8%, about 52.8% to about 86.7%, about 52.9% to about 86.6%, about 53.0% to about 86.5%, about 53.1% to about 86.4%, about 53.2% to about 86.3%, about 53.3% to about 86.2%, about 53.4% to about 86.1%, about 53.5% to about 86.0%, about 53.6% to about 85.9%, about 53.7% to about 85.8%, about 53.8% to about 85.7%, about 53.9% to about 85.6%, about 54.0% to about 85.5%, about 54.1% to about 85.4%, about 54.2% to about 85.3%, about 54.3% to about 85.2%, about 54.4% to about 85.1%, about 54.5% to about 85.0%, about 54.6% to about 84.9%, about 54.7% to about 84.8%, about 54.8% to about 84.7%, about 54.9% to about 84.6%, or about 55.0% to about 84.5% by weight of the total pesticidal suspension composition.

In certain embodiments, water may be present in an amount of about 55% to about 84.5% by weight of the total pesticidal suspension composition. For example, water may be present in an amount of about 55.1% to about 84.4%, about 55.2% to about 84.3%, about 55.3% to about 84.2%, about 55.4% to about 84.1%, about 55.5% to about 84.0%, about 55.6% to about 83.9%, about 55.7% to about 83.8%, about 55.8% to about 83.7%, about 55.9% to about 83.6%, about 56.0% to about 83.5%, about 56.1% to about 83.4%, about 56.2% to about 83.3%, about 56.3% to about 83.2%, about 56.4% to about 83.1%, about 56.5% to about 83.0%, about 56.6% to about 82.9%, about 56.7% to about 82.8%, about 56.8% to about 82.7%, about 56.9% to about 82.6%, about 57.0% to about 82.5%, about 57.1% to about 82.4%, about 57.2% to about 82.3%, about 57.3% to about 82.2%, about 57.4% to about 82.1%, about 57.5% to about 82.0%, about 57.6% to about 81.9%, about 57.7% to about 81.8%, about 57.8% to about 81.7%, about 57.9% to about 81.6%, about 58.0% to about 81.5%, about 58.1% to about 81.4%, about 58.2% to about 81.3%, about 58.3% to about 81.2%, about 58.4% to about 81.1%, about 58.5% to about 81.0%, about 58.6% to about 80.9%, about 58.7% to about 80.8%, about 58.8% to about 80.7%, about 58.9% to about 80.6%, about 59.0% to about 80.5%, about 59.1% to about 80.4%, about 59.2% to about 80.3%, about 59.3% to about 80.2%, about 59.4% to about 80.1%, about 59.5% to about 80.0%, about 59.6% to about 79.9%, about 59.7% to about 79.8%, about 59.8% to about 79.7%, about 59.9% to about 79.6%, about 60.0% to about 79.5%, about 60.1% to about 79.4%, about 60.2% to about 79.3%, about 60.3% to about 79.2%, about 60.4% to about 79.1%, about 60.5% to about 79.0%, about 60.6% to about 78.9%, about 60.7% to about 78.8%, about 60.8% to about 78.7%, about 60.9% to about 78.6%, about 61.0% to about 78.5%, about 61.1% to about 78.4%, about 61.2% to about 78.3%, about 61.3% to about 78.2%, about 61.4% to about 78.1%, about 61.5% to about 78.0%, about 61.6% to about 77.9%, about 61.7% to about 77.8%, about 61.8% to about 77.7%, about 61.9% to about 77.6%, about 62.0% to about 77.5%, about 62.1% to about 77.4%, about 62.2% to about 77.3%, about 62.3% to about 77.2%, about 62.4% to about 77.1%, about 62.5% to about 77.0%, about 62.6% to about 76.9%, about 62.7% to about 76.8%, about 62.8% to about 76.7%, about 62.9% to about 76.6%, about 63.0% to about 76.5%, about 63.1% to about 76.4%, about 63.2% to about 76.3%, about 63.3% to about 76.2%, about 63.4% to about 76.1%, about 63.5% to about 76.0%, about 63.6% to about 75.9%, about 63.7% to about 75.8%, about 63.8% to about 75.7%, about 63.9% to about 75.6%, about 64.0% to about 75.5%, about 64.1% to about 75.4%, about 64.2% to about 75.3%, about 64.3% to about 75.2%, about 64.4% to about 75.1%, about 64.5% to about 75.0%, about 64.6% to about 74.9%, about 64.7% to about 74.8%, about 64.8% to about 74.7%, about 64.9% to about 74.6%, about 65.0% to about 74.5%, about 65.1% to about 74.4%, about 65.2% to about 74.3%, about 65.3% to about 74.2%, about 65.4% to about 74.1%, about 65.5% to about 74.0%, about 65.6% to about 73.9%, about 65.7% to about 73.8%, about 65.8% to about 73.7%, about 65.9% to about 73.6%, about 66.0% to about 73.5%, about 66.1% to about 73.4%, about 66.2% to about 73.3%, about 66.3% to about 73.2%, about 66.4% to about 73.1%, about 66.5% to about 73.0%, about 66.6% to about 72.9%, about 66.7% to about 72.8%, about 66.8% to about 72.7%, about 66.9% to about 72.6%, about 67.0% to about 72.5%, about 67.1% to about 72.4%, about 67.2% to about 72.3%, about 67.3% to about 72.2%, about 67.4% to about 72.1%, about 67.5% to about 72.0%, about 67.6% to about 71.9%, about 67.7% to about 71.8%, about 67.8% to about 71.7%, about 67.9% to about 71.6%, about 68.0% to about 71.5%, about 68.1% to about 71.4%, about 68.2% to about 71.3%, about 68.3% to about 71.2%, about 68.4% to about 71.1%, about 68.5% to about 71.0%, about 68.6% to about 70.9%, about 68.7% to about 70.8%, about 68.8% to about 70.7%, about 68.9% to about 70.6%, about 69.0% to about 70.5%, about 69.1% to about 70.4%, about 69.2% to about 70.3%, about 69.3% to about 70.2%, about 69.4% to about 70.1%, or about 69.5% to about 70.0% by weight of the total pesticidal suspension composition.

In certain embodiments, the water is present in an amount of about 55% to about 65% by weight of the total pesticidal suspension composition. For example, the water may be present in an amount of about 55.1% to about 64.9%, about 55.5% to about 64.5%, about 56.0% to about 64.0%, about 56.5% to about 63.5%, about 57.0% to about 63.0%, about 57.5% to about 62.5%, about 58.0% to about 62.0%, about 58.5% to about 61.5%, about 59.0% to about 61.0%, about 59.5% to about 60.5%, or about 60.0% to about 60.0% by weight of the total pesticidal suspension composition.

In one illustrative embodiment, the pesticidal suspension composition may include about 22 wt % indoxacarb, about 5 wt % dispersant, about 1.5-2 wt % surfactant, and the balance water, and may optionally further include an antifreeze agent (e.g., about 10-15 wt %), a thickener (e.g., less than about 1 wt %), a preservative (e.g., less than about 1 wt %), and/or an antifoaming agent (e.g., about 1-2 wt %). It will be understood that the specific amounts of the individual components may be varied within the ranges described herein while maintaining indoxacarb as a stable suspension suitable for pesticidal use.

### II. METHODS OF USE

One aspect of the present disclosure encompasses a method of controlling a target pest. The method comprises contacting the pest with a pesticidally effective amount of a composition comprising a pesticidally effective concentration of a pesticidally active solid particulate voltage-dependent sodium channel blocker. The composition may be as described in Section I above.

A pesticidally effective amount may be determined by the efficacy or potency of the particular composition, the pest being controlled, the duration or frequency of application of the pesticidal composition, and the method of application of the composition. A pesticidally effective amount may be determined using methods known in the art, and may be determined experimentally. Additionally, the method of application may be considered when determining the pesticidally effective amount. In determining pesticidally effective amounts, one skilled in the art may also consider the existence of resistance of the pest to pesticides. Importantly, the pest may be contacted at any stage of development of the pest. This is because the method can control current and future pest generations independent of application timing with respect to the life stage of the pest.

Another aspect of the instant disclosure encompasses a method of treating pest infestations in animals. The method comprising pouring onto the external skin of the animal to be treated an effective amount of a pesticidal suspension composition for control of pests on animals, wherein the pesticidal suspension composition is capable of diffusing over the body of the domestic animal when applied to a localized region of the domestic animal, thereby protecting the animal from pests. The pesticidal suspension composition may be as described in Section I above.

The animals may be cattle, and the pests may be ectoparasites such as horn flies and lice. In certain embodiments, the animals are cattle, and the pests and horn flies. In other aspects, the animals are cattle, and the pests and lice.

In one aspect, the disclosure provides a method of controlling pests. The method may include applying an effective amount of a pesticide composition comprising indoxacarb to a target area. In certain embodiments, the pesticide composition comprises about 20% to about 21% by weight indoxacarb. The application may be effective in controlling one or more pests infesting turfgrass or ornamental plants.

The pesticide composition may be applied to any suitable target area, including but not limited to turfgrass areas and ornamental plantings. The term “target area” may include soil, foliage, thatch, plant surfaces, or surrounding areas where pests are present or expected to be present.

In some embodiments, the pests controlled may include black cutworm larvae, tawny mole cricket, Genista caterpillar, or any combination thereof.

In certain embodiments, the target area may include cool-season turfgrass, and the pests controlled include black cutworm larvae. In other embodiments, the target area may include warm-season turfgrass, and the pests controlled include tawny mole cricket. In further embodiments, the target area may include ornamental plants, and the pests controlled include Genista caterpillar.

The pesticide composition may be applied using any suitable application technique, including spraying, broadcasting, or other conventional pesticide application methods. The composition may be applied as formulated or after dilution with water to form a spray solution or diluted suspension.

In some embodiments, the applying step may include applying the pesticide composition at a rate of about 0.1 fluid ounces (fl oz) per 1,000 square feet (ft²) of the target area. For example, the applying step may comprise applying the pesticide composition at a rate of about 0.11, about 0.12, about 0.13, about 0.14, about 0.15, about 0.16, about 0.17, about 0.18, about 0.19, or about 0.20 fl oz per 1,000 ft² of the target area. In other embodiments, the applying step comprises applying the pesticide composition at a rate ranging from about 0.3 to about 0.9 fl oz per 1,000 ft².

In other embodiments, the applying step may include applying the pesticide composition at a rate ranging from about 0.3 to about 0.9 fluid ounces per 1,000 square feet of the target area. For example, the applying step may comprise applying the pesticide composition at a rate of about 0.31 to about 0.89, about 0.32 to about 0.88, about 0.33 to about 0.87, about 0.34 to about 0.86, about 0.35 to about 0.85, about 0.36 to about 0.84, about 0.37 to about 0.83, about 0.38 to about 0.82, about 0.39 to about 0.81, about 0.40 to about 0.80, about 0.41 to about 0.79, about 0.42 to about 0.78, about 0.43 to about 0.77, about 0.44 to about 0.76, about 0.45 to about 0.75, about 0.46 to about 0.74, about 0.47 to about 0.73, about 0.48 to about 0.72, about 0.49 to about 0.71, about 0.50 to about 0.70, about 0.51 to about 0.69, about 0.52 to about 0.68, about 0.53 to about 0.67, about 0.54 to about 0.66, about 0.55 to about 0.65, about 0.56 to about 0.64, about 0.57 to about 0.63, about 0.58 to about 0.62, or about 0.59 to about 0.61 fl oz per 1,000 ft² of the target area.

In further embodiments, the applying step may include applying the pesticide composition at a rate ranging from about 1.1 to about 2.9 fl oz per 100 gallons of water, for example, when the composition is diluted to form a spray solution prior to application. The rate may be from about 1.2 to about 2.8, about 1.3 to about 2.7, about 1.4 to about 2.6, about 1.5 to about 2.5, about 1.6 to about 2.4, about 1.7 to about 2.3, about 1.8 to about 2.2, or about 1.9 to about 2.1 fl oz per 100 gallons of water.

The application rate and method may be selected based on factors such as the type of pest, the target area, environmental conditions, and desired level of pest control. The methods described herein may provide effective pest control while maintaining acceptable plant safety when applied under labeled use conditions.

### III. KITS

A further aspect of the present disclosure provides kits comprising one or more pesticidal compositions comprising a pesticidally effective concentration of a pesticidally active solid particulate voltage-dependent sodium channel blocker detailed above. The one or more pesticidal compositions may be administered by a method described above.

The kits may further comprise a suspending vehicle appropriate for diluting a suspension concentrate composition. The compositions may be packaged in one or more containers. The containers can further comprise means of administering or measuring the compositions. For instance, if the composition is a suspension concentrate, the container may further comprise a means of spraying the composition, and a measuring cup for measuring an appropriate volume of the concentrate for dilution. When the composition is a powder composition, the container may be a container operable to spray the powder.

The kits provided herein generally include instructions for carrying out the methods detailed above. Instructions included in the kits may be affixed to packaging material or may be included as a package insert. While the instructions are typically written or printed materials, they are not limited to such. Any medium capable of storing such instructions and communicating them to an end user is contemplated by this disclosure. Such media include, but are not limited to, electronic storage media (e.g., magnetic discs, tapes, cartridges, chips), optical media (e.g., CD ROM), and the like. As used herein, the term “instructions” may include the address of an internet site that provides the instructions.

### Definitions

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there may be additional elements other than the listed elements.

As used herein, the term “consisting essentially of” means that the claimed invention includes the listed elements and may include additional, unlisted elements only if those additional elements do not materially affect the basic and novel characteristics of the invention.

The term “pesticidally effective amount” as used herein refers to an amount effective, at dosages, and for periods of time necessary, to achieve the desired result with respect to the control of a pest. For example, in the control of an agricultural pest, an agent (i.e., a compound or a composition) which decrease, prevents, delays or suppresses or arrests damage to an agricultural crop caused by a pest would be effective. The pesticidally effective amount may be divided into one, two or more applications in a suitable form to be applied one, two or more times throughout a designated time period.

As various changes could be made in the above-described cells and methods without departing from the scope of the invention, it is intended that all matter contained in the above description and in the examples given below, shall be interpreted as illustrative and not in a limiting sense.

As used herein, the term “suspension concentrate” refers to a concentrated form of the suspension composition, wherein the concentrate comprises all the ingredients of the composition in a concentrated form. Accordingly, a suspension concentrate is diluted to a pesticidally effective concentration of voltage-dependent sodium channel blocker prior to application by, e.g., spraying the diluted concentrate.

As used herein, a “stable suspension” refers to a composition in which the active particles remain substantially uniformly dispersed over time, with limited settling and the ability to be readily re-dispersed upon agitation.

As used herein, the term “suspension composition” refers to a liquid composition comprising solid particles of a voltage-dependent sodium channel blocker stably and substantially uniformly distributed throughout a suspending medium. The voltage-dependent sodium channel blocker is substantially insoluble in the suspending medium and is present predominantly in particulate form rather than in dissolved form. Accordingly, in certain embodiments, the suspension composition is substantially free of solvents present in amounts sufficient to solubilize the voltage-dependent sodium channel blocker.

As used herein, the term “target area” may include soil, foliage, thatch, plant surfaces, or surrounding areas where pests are present or expected to be present.

### EXAMPLES

All patents and publications mentioned in the specification are indicative of the levels of those skilled in the art to which the present disclosure pertains. All patents and publications are herein incorporated by reference to the same extent as if each individual publication was specifically and individually indicated to be incorporated by reference.

The publications discussed throughout are provided solely for their disclosure before the filing date of the present application. Nothing herein is to be construed as an admission that the invention is not entitled to antedate such disclosure by virtue of prior invention.

The following examples are included to demonstrate the disclosure. It should be appreciated by those of skill in the art that the techniques disclosed in the following examples represent techniques discovered by the inventors to function well in the practice of the disclosure. Those of skill in the art should, however, in light of the present disclosure, appreciate that many changes could be made in the disclosure and still obtain a like or similar result without departing from the spirit and scope of the disclosure, therefore all matter set forth is to be interpreted as illustrative and not in a limiting sense.

### Example 1: Preparation of Pesticidal Suspension Compositions

Five pesticidal suspension compositions were prepared. The compositions are listed in Tables 1-5.

TABLE 1
Pesticidal suspension 1

| Ingredient | % w/w |
|---|---|
| Indoxacarb Tech 9:1 | 6.93 |
| Aerosol® OT-75Â | 1.13 |
| Soprophor® FLK (441 lb Drum) | 2.00 |
| Agnique® DFM111S 40 lb. pail | 0.25 |
| Propylene Glycol | 3.87 |
| Ticaxan® pre-hydrated Xanthan | 0.30 |
| Proxel® GXL (440 lb drum) | 0.20 |
| Proxel® BN (440 lb drum) | 0.20 |
| Water | 85.13 |

TABLE 2
Pesticidal suspension 2

| Ingredient | % w/w |
|---|---|
| Indoxacarb Tech 9:1 | 6.92 |
| Pyriproxyfen Tech | 1.33 |
| Novaluron Technical 98.5% | 1.31 |
| Aerosol® OT-75Â 475 lb drum | 1.13 |
| Soprophor® FLK (441 lb Drum) | 2.00 |
| Agnique® DFM111S | 0.25 |
| Propylene Glycol | 3.87 |
| Ticaxan® pre-hydrated Xanthan | 0.30 |
| Proxel® GXL (440 lb drum) | 0.4 |
| Water | 85.13 |

TABLE 3
Pesticidal suspension 3

| Ingredient | % w/w |
|---|---|
| Indoxacarb Tech 9:1 | 22.6 |
| Xantham Gum-FG 200 | 0.23 |
| mesh ADM | |
| Proxel® GXL (440 lb drum) | 0.43 |
| Atlox™ 4913 | 5.22 |
| Ethylan | 1.74 |
| Propylene Glycol | 13.04 |
| SAG™ 30/AF 30 | 1.74 |
| Water | 54.99 |

TABLE 4
Pesticidal suspension 4

| Ingredient | % w/w |
|---|---|
| Indoxacarb Tech 9:1 | 7.0331 |
| Imidacloprid Technical (98.2%) | 6.6191 |
| Pyriproxyfen (98.4%) | 1.3211 |
| Xanthan Gum | 0.2000 |
| Proxel® GXL | 0.2000 |
| Atlox™ 4913 | 1.5000 |
| Step-Flow® 26F | 1.5000 |
| Ethox® 4420 | 2.5000 |
| Propylene Glycol | 10.0000 |
| SAG™ 30 | 1.0000 |
| Soprophor® FLK | 1.0000 |
| Polysorbate 80 | 3.0000 |
| Water | 64.1266 |

TABLE 5
Pesticidal suspension 5

| Ingredient | % w/w |
|---|---|
| Indoxacarb Tech 9:1 | 7.0331 |
| Imidacloprid Technical (98.2%) | 6.6191 |
| Xanthan Gum | 0.2000 |
| Proxel® GXL | 0.2000 |
| Atlox™ 4913 | 0.5000 |
| Step-Flow® 26F | 6.0000 |
| Propylene Glycol | 10.0000 |
| SAG™ 30 | 1.0000 |
| Soprophor® FLK | 1.0000 |
| Water | 67.9477 |

### Example 2: Evaluation of Pesticidal Suspension Compositions as a Direct Spray Application Against Three Genera of Adult Public Health Pest Mosquitoes

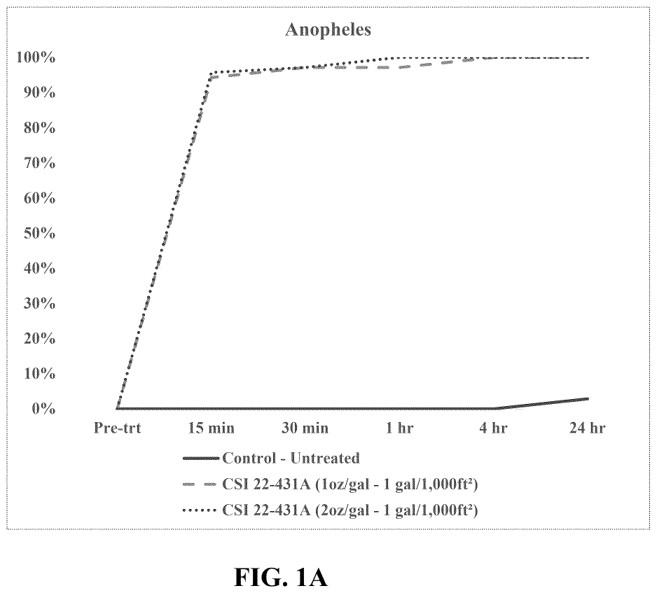

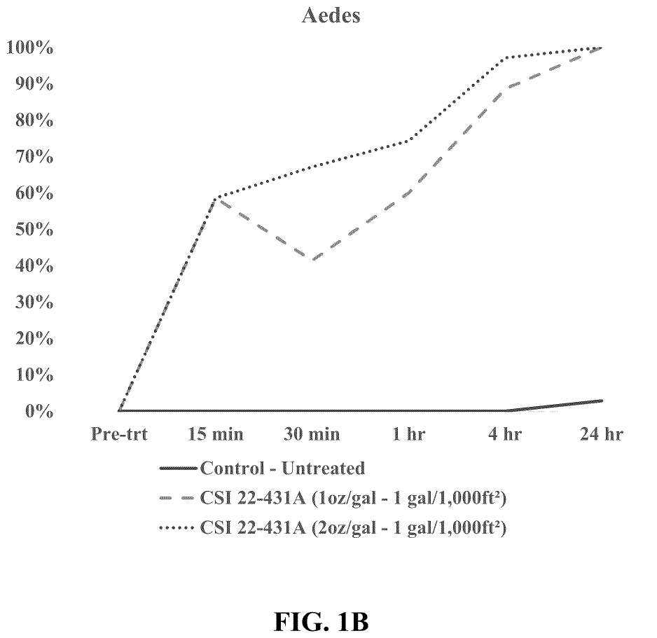

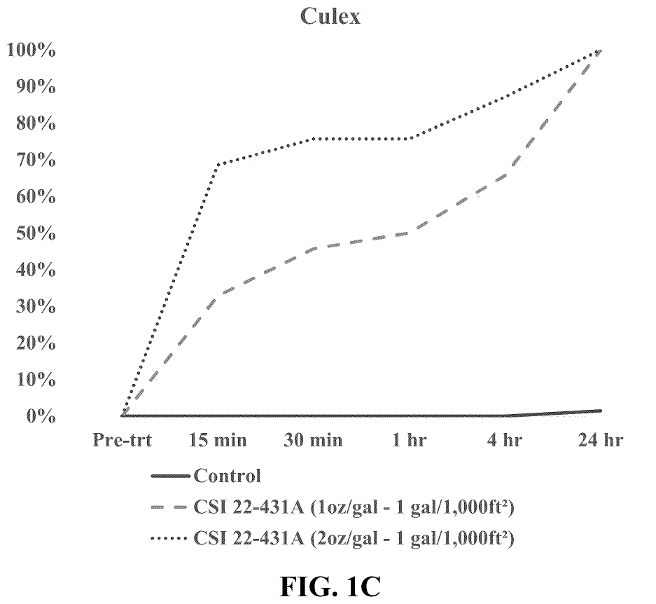

A laboratory efficacy study comparing a single application of two rates of the test substance compared to a negative control when sprayed directly to mosquitoes was conducted. Following test substance application and pest exposure to the treatments, observations were made on the experimental units at 15 min., 30 min., 1 h., 4 h., 24 h., 48 h., 72 h., and 96 h. FIG. 1A shows the graph of mean percent mortality of Anopheles mosquitoes exposed to Indox SC. FIG. 1B shows the graph of mean percent mortality of Aedes mosquitoes exposed to Indox SC. FIG. 1C shows the graph of mean percent mortality of Culex mosquitoes exposed to Indox SC. FIGS. 1A-1C show Indox SC was effective against all three mosquito species when applied as direct spray.

### Example 3: Evaluation of Pesticidal Suspension Compositions Vs. Occasional Invaders in Mulch

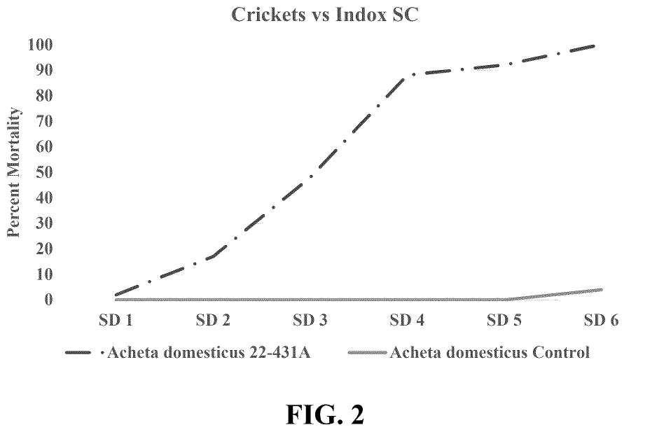

A laboratory efficacy study comparing the residual application (30 d) of the lowest label rate of the test substance to negative controls when applied to the top of mulch was conducted. Cricket control was too high for the 30 d study and was re-ran for 24 hr after unsatisfactory results with pillbugs and millipedes with 30 d residuals. Following test substance application, daily (repeated) observations were made on the experimental units for 14 days. FIG. 2 shows percent mortality of crickets over 6 days to 24-hour aged.

### Example 4: Black Cutworm Control on Cool-Season Turf Using Pesticidal Suspension 3

An efficacy trial was conducted to evaluate the performance and plant safety of an indoxacarb suspension concentrate (pesticidal suspension 3) on cool-season turfgrass infested with black cutworm larvae. The study was conducted at a research site in Pennsylvania.

Plots of cool-season turfgrass were treated on Aug. 2, 2023, with various insecticide treatments. The indoxacarb formulation evaluated was a suspension concentrate comprising 20.9% by weight indoxacarb (pesticidal suspension 3). The formulation was applied as a diluted spray at a carrier volume of approximately 87 gallons per acre. The indoxacarb formulation was applied at a rate of about 0.1 fl oz per 1,000 ft², corresponding to approximately 0.00148 pounds of active ingredient per 1,000 ft². Comparative treatments included a commercially available indoxacarb formulation Provaunt® SC at 0.14 oz per 1,000 ft² and Suprado® at 2.94 fl oz. per 1,000 ft². Untreated plots served as controls.

Following the application, plots were assessed for black cutworm larvae. Total larvae recovered were recorded, and the percent control was calculated relative to untreated plots. Phytotoxicity was also evaluated visually throughout the assessment period.

Table 6 summarizes the application rates, average number of larvae recovered per plot, and percent control observed for each treatment. As shown in Table 6, the indoxacarb suspension concentrate applied at 0.1 fl oz per 1,000 ft² resulted in zero larvae recovered and 100% control relative to untreated plots, which exhibited an average of approximately eight larvae per plot. The indoxacarb suspension concentrate provided control comparable to one comparative insecticide treatment and greater control than another comparative indoxacarb formulation applied at a higher active ingredient rate.

TABLE 6

| | | Average larvae | | |
|---|---|---|---|---|
| | Product Rate | recovered | | |
| Treatment Name | (per 1000 ft²) | (+/- Std Err) | Control | MS |
| Untreated | | 8.13 ± 0.64 | | A |
| Indoxacarb 20.9 | 0.1 fl oz | 0.00 ± 0.00 | 100% | B |
| Provaunt® SC | 0.14 oz | 0.63 ± 0.50 | 92% | B |
| Suprado® | 2.94 fl oz. | 0.00 ± 0.00 | 100% | B |

Means followed by the same letter are not significantly different (LSD, P = 0.05).

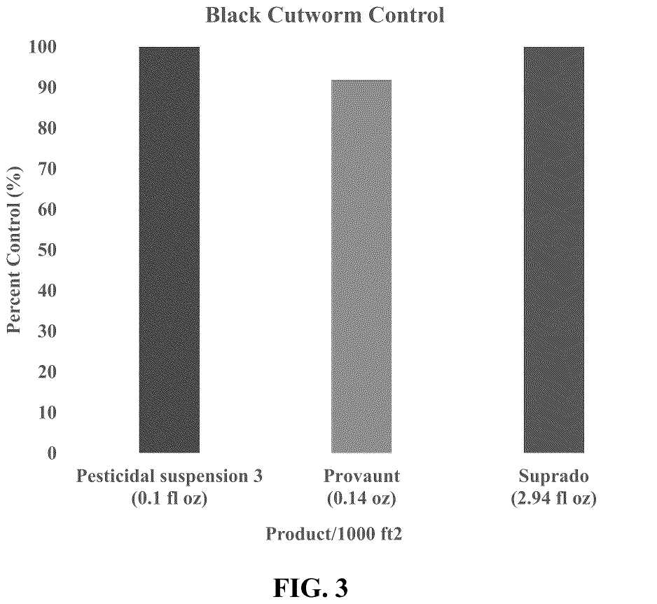

FIG. 3 is a bar graph summarizing the percent control of black cutworm for each treatment. As illustrated, applications of pesticidal suspension 3 at 0.1 fl oz per 1,000 ft² and Suprado® at 2.94 fl oz per 1,000 ft² each resulted in 100% control of black cutworm relative to the untreated plots. Provaunt® SC, applied at 0.14 oz per 1,000 ft², provided approximately 92% control. The figure demonstrates that pesticidal suspension 3 surprisingly achieved complete control at a substantially lower application rate of active ingredient compared with the competitive standard, while maintaining equivalent efficacy to the higher-rate Suprado® treatment.

The indoxacarb suspension concentrate (Pesticidal suspension 3) applied at 0.1 fl oz. per 1,000 ft² resulted in complete control of black cutworm larvae, with no larvae recovered from treated plots. This corresponded to 100% control relative to untreated plots, which exhibited an average of approximately eight larvae per plot. The indoxacarb suspension concentrate provided control comparable to one comparative insecticide treatment and greater control than another comparative indoxacarb formulation applied at a higher active ingredient rate. No phytotoxicity was observed on the treated turfgrass for any of the treatments evaluated.

This example demonstrates that an indoxacarb suspension concentrate applied at a relatively low application rate can provide effective control of black cutworm larvae on cool-season turfgrass without causing observable phytotoxicity.

### Example 5: Performance and Turf Safety of Pesticidal Suspension Composition 3 to Warm Season Turf—Summer Applied—Tawny Mole Cricket

A field study was conducted to evaluate the efficacy and turf safety of an indoxacarb suspension concentrate for control of tawny mole cricket on warm-season turfgrass under summer application conditions. The study was conducted in 2023 at a golf course in Florida.

Plots of warm-season turfgrass (Bermudagrass cultivar ‘Tifway’) maintained at approximately 0.5 inches in height were treated with insecticide formulations. The indoxacarb formulation evaluated was a suspension concentrate comprising 20.9% by weight indoxacarb (pesticidal suspension composition 3). Applications were made on Jun. 28 and Jul. 12, 2023, at a carrier volume of approximately 43 gallons per acre, followed by post-application irrigation of approximately 0.25 inches. The indoxacarb suspension concentrate was applied at rates of about 0.3 fl oz and about 0.9 fl oz per 1,000 ft². A commercially available indoxacarb formulation (Provaunt® 0.275 oz per 1,000 ft²) was applied as a comparative treatment. Untreated plots served as controls.

Tawny mole cricket populations were assessed prior to treatment (0 days after initial treatment) and at approximately 28 and 42 days after the initial treatment. Insect counts were recorded for each plot, and turfgrass was visually evaluated for phytotoxicity throughout the study.

Table 7 summarizes the average number of tawny mole crickets observed for each treatment at the assessment intervals. As shown in Table 7, untreated plots exhibited increased insect counts at post-treatment assessments. In contrast, plots treated with the indoxacarb suspension concentrate at both application rates showed a rapid reduction in mole cricket populations, with substantial suppression observed by 28 days after treatment and near-complete control maintained through at least 42 days after the initial application.

TABLE 7

| | Product | | | | | | | |
|---|---|---|---|---|---|---|---|---|
| | Rate (per | | | | | | | |
| Treatment Name | 1000 ft²) | | Day 0 | | Day 28 | | Day 42 | |
| Untreated | | | 7 | — | 11.8 | a | 7.8 | a |
| Indoxacarb 20.9% | 0.3 | fl oz | 7.8 | — | 0.0 | b | 0.3 | b |
| Indoxacarb 20.9% | 0.9 | fl oz | 7.5 | — | 0.0 | b | 0.0 | b |
| Provaunt ® | 0.275 | oz | 7.8 | — | 0.0 | b | 0.0 | b |

Means followed by the same letter are not significantly different (LSD, P = 0.05).

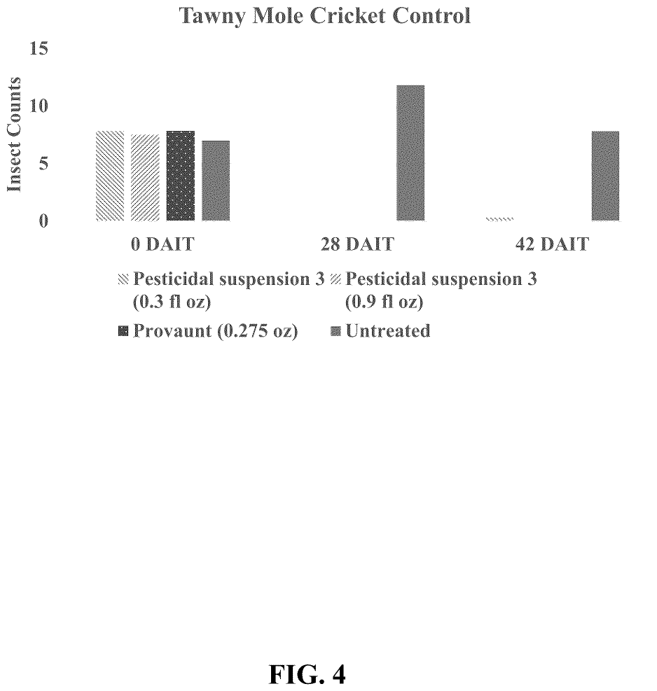

FIG. 4 illustrates the average tawny mole cricket counts observed at 0, 28, and 42 days after initial treatment (DAIT) for the treated and untreated plots. As shown in FIG. 4, insect counts were similar across all plots prior to treatment, while plots treated with the indoxacarb suspension concentrate and the comparative indoxacarb formulation exhibited substantially reduced insect counts relative to untreated plots at post-treatment assessment intervals.

No phytotoxicity or turfgrass injury was observed in any of the treated plots during the study. Treated plots exhibited turf quality equal to or better than that observed in untreated plots by the end of the evaluation period.

This example demonstrates that an indoxacarb suspension concentrate can provide rapid and sustained control of tawny mole cricket on warm-season turfgrass following summer application, without causing observable phytotoxicity.

### Example 6: Extended Control of Tawny Mole Cricket on Warm-Season Turfgrass

A field study was conducted to evaluate the efficacy and turf safety of an indoxacarb suspension concentrate for control of tawny mole cricket on warm-season turfgrass during summer application conditions. The study was conducted at a golf course in North Carolina.

Plots of warm-season turfgrass (Bermudagrass cultivar ‘419’) maintained at approximately 2 inches in height were treated with insecticide formulations. The indoxacarb formulation evaluated was a suspension concentrate comprising 20.9% by weight indoxacarb (pesticidal suspension 3). Applications were made on Jul. 19 and Aug. 3, 2024, at a carrier volume of approximately 50 gallons per acre, followed by post-application irrigation of approximately 0.25 inches. The indoxacarb suspension concentrate was applied at rates of about 0.3 fl oz and about 0.9 fl oz 1,000 ft². Comparative treatments included a commercially available indoxacarb formulations (Provaunt® applied at 0.275 oz and Topchoice® applied at 2.0 lb). Untreated plots served as controls.

Tawny mole cricket damage was evaluated at approximately 12, 26, 46, and 56 days after the initial treatment (DAIT). Turf damage was assessed using a numerical rating scale from 0 to 9, where 0 represented no observable damage and 9 represented damage across all evaluated subsections. Turfgrass was monitored throughout the study for phytotoxicity.

Table 8 summarizes the average turf damage ratings observed for each treatment at the evaluation intervals. As shown in Table 8, plots treated with the indoxacarb suspension concentrate at both application rates exhibited significantly lower damage ratings relative to untreated plots at all assessment time points. Reduced turf damage was observed as early as 12 days after treatment and was maintained through at least 56 days after the initial application. Damage ratings in the indoxacarb-treated plots were comparable to those observed for the comparative insecticide treatments over the duration of the study.

TABLE 8

| Treatment | Product Rate | | | | | | | | | |
|---|---|---|---|---|---|---|---|---|---|---|
| Name | (per 1000 ft²) | | Day 12 | | Day 26 | | Day 46 | | Day 56 | |
| Untreated | | | 4.5 | b | 4.87 | c | 4.75 | c | 5.00 | c |
| Indoxacarb 20.9 | 0.3 | fl oz | 1.5 | a | 2.62 | b | 2.00 | b | 2.37 | b |
| Indoxacarb 20.9 | 0.9 | fl oz | 1.25 | a | 2.12 | ab | 1.75 | b | 1.87 | ab |
| Provaunt ® | 0.275 | oz | 1.37 | a | 1.62 | a | 2.00 | b | 2.00 | b |
| Topchoice ® | 2.0 | lb | 1.00 | a | 1.87 | ab | 1.25 | a | 1.25 | a |

Means followed by the same letter are not significantly different (LSD, P = 0.05).

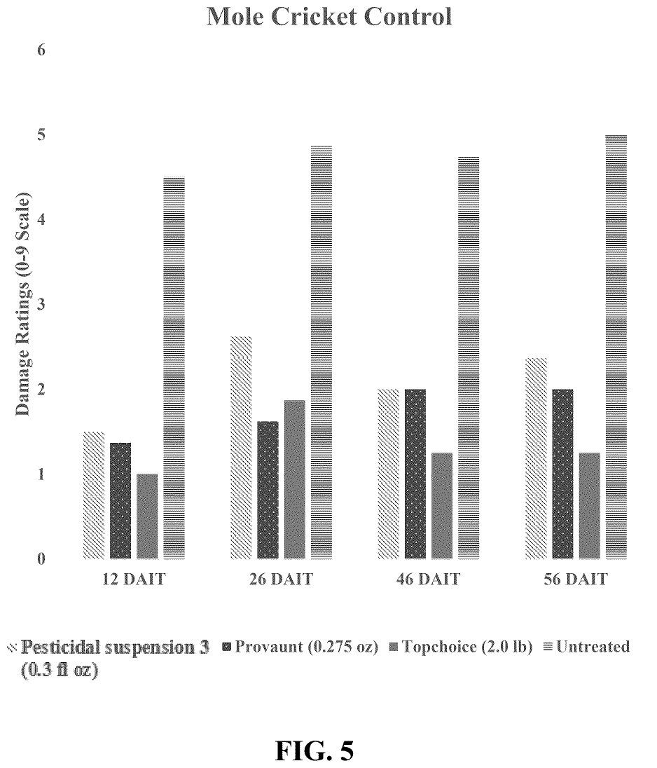

FIG. 5 illustrates the progression of turf damage ratings over time for treated and untreated plots. As shown in FIG. 5, two applications of the indoxacarb suspension concentrate provided sustained protection against turf damage over the evaluation period.

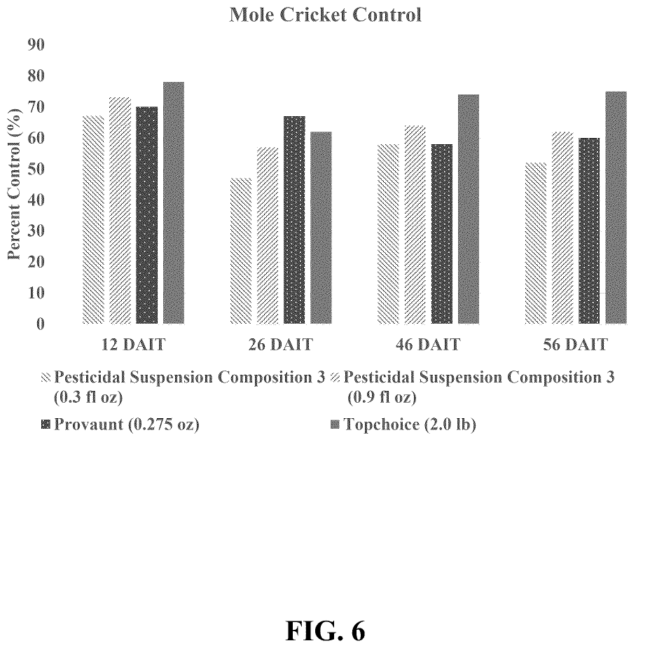

FIG. 6 is a bar graph illustrating percent control of tawny mole cricket on warm-season turfgrass at multiple assessment intervals following application of insecticide treatments. The horizontal axis represents assessment timing at 12, 26, 46, and 56 days after initial treatment (DAIT). The vertical axis represents percent control relative to untreated plots. Bars correspond to treatments including an indoxacarb suspension concentrate applied at 0.3 fl oz and 0.9 fl oz per 1,000 ft², a comparative indoxacarb formulation Provaunt® applied at 0.275 fl oz per 1,000 ft², and Topchoice® applied at 2 lb per 1,000 ft².

As shown in FIG. 6, treatments comprising the indoxacarb suspension concentrate provided sustained levels of control over the evaluation period, with percent control remaining at elevated levels through at least 56 days after initial treatment and comparable to the comparative treatments.

No phytotoxicity or turfgrass injury was observed in any of the treated plots during the study. All insecticide treatments resulted in statistically significant reductions in turf damage relative to the untreated control.

This example demonstrates that an indoxacarb suspension concentrate applied to warm-season turfgrass can provide extended control of tawny mole cricket and long-lasting protection against turf damage without causing observable phytotoxicity.

### Example 7: Control of Genista Caterpillar on Ornamental Plants

A field study was conducted to evaluate the efficacy and plant safety of an indoxacarb suspension concentrate for control of Genista caterpillar on ornamental plants under fall application conditions. The study was conducted in 2024 at a site in California.

Container-grown ornamental plants comprising Saphora Mountain Laurel (1-gallon trade size containers) were treated with insecticide formulations on Nov. 22, 2024. The indoxacarb formulation evaluated was a suspension concentrate comprising 20.9% by weight indoxacarb (pesticidal suspension 3). Applications were made as foliar sprays at a spray volume equivalent to approximately 100 gallons per acre. The indoxacarb suspension concentrate was applied at rates of about 1.1 fl oz and about 2.9 fl oz per 100 gallons of water, corresponding to approximately 0.016 pounds and 0.043 pounds of active ingredient per 100 gallons, respectively. Comparative treatments included a commercially available indoxacarb formulation applied at labeled rates of about 1.88 ounces and about 3.75 ounces per 100 gallons. Untreated plants served as controls.

Assessments of insect damage were conducted at approximately 3, 10, 13, 19, and 35 days after initial treatment. Damage ratings were based on total percent feeding damage observed on the treated plants. Plants were also visually evaluated throughout the study for signs of phytotoxicity.

Table 9 summarizes the average percent damage observed for each treatment at the assessment intervals. As shown in Table 9, untreated plants exhibited progressively increasing damage over time. In contrast, plants treated with the indoxacarb suspension concentrate at both application rates exhibited substantially reduced feeding damage relative to untreated plants at all assessment time points. The level of control provided by the indoxacarb suspension concentrate was comparable to that observed for the comparative indoxacarb formulation over the duration of the study.

TABLE 9

| Treatment | Product Rate | | | | | | | | | | | |
|---|---|---|---|---|---|---|---|---|---|---|---|---|
| Name | (per 1000 ft²) | | Day 3 | | Day 10 | | Day 13 | | Day 19 | | Day 35 | |
| Untreated | | | 6.3 | a | 16.3 | a | 20.5 | a | 20.5 | a | 22.8 | a |
| Indoxacarb 20.9 | 1.1 | fl oz | 3.3 | a | 4.3 | a | 4.0 | a | 3.3 | a | 1.3 | a |
| Indoxacarb 20.9 | 2.9 | fl oz | 2.3 | a | 3.3 | a | 3.0 | a | 3.3 | a | 2.5 | a |
| Provaunt ® | 1.88 | oz | 2.8 | a | 3.5 | a | 2.8 | a | 1.8 | a | 3.3 | a |
| Provaunt ® | 3.75 | oz | 2.5 | a | 3.8 | a | 4.5 | a | 5.8 | a | 7.0 | a |

Means followed by the same letter are not significantly different (LSD, P = 0.05).

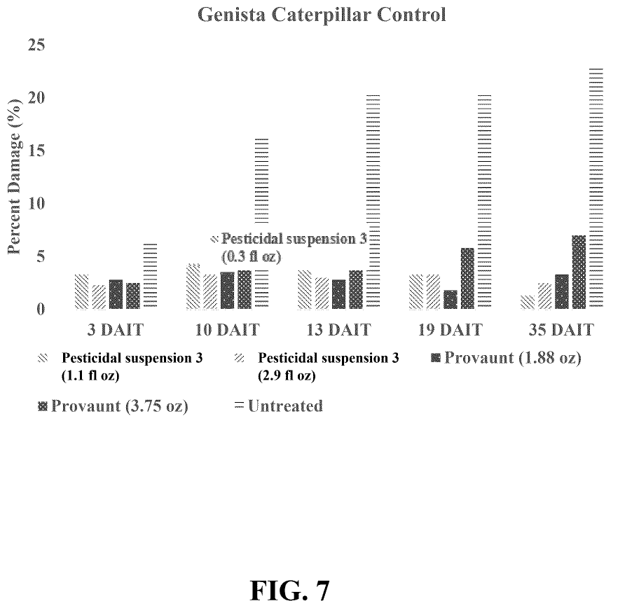

FIG. 7 illustrates the percent feeding damage observed on treated and untreated plants at the various assessment intervals. As shown in FIG. 7, plants treated with the indoxacarb suspension concentrate maintained low levels of damage throughout the evaluation period.

No phytotoxicity or adverse effects on the ornamental plants were observed for any of the treatments evaluated.

This example demonstrates that an indoxacarb suspension concentrate can provide effective control of Genista caterpillar on ornamental plants when applied at relatively low active ingredient rates, while maintaining acceptable plant safety under fall application conditions.

What is claimed is:

1. A pesticidal suspension composition comprising:
5-30% indoxacarb by weight of the suspension;
4.5-6% dispersant by weight of the suspension;
1-2% surfactant by weight of the suspension; and
water;
wherein the dispersant and surfactant are present in amounts effective to maintain the indoxacarb as a stable suspension during storage.

2. The pesticidal suspension composition of claim 1, wherein the amount of indoxacarb is about 20 to about 25% by weight of the suspension.

3. The pesticidal suspension composition of claim 1, wherein the dispersant is selected from polymeric dispersants, lignosulfonates, naphthalene sulfonate condensates, polycarboxylates, and combinations thereof.

4. The pesticidal suspension composition of claim 3, wherein the polymeric dispersants are selected from polyether-based polymeric dispersants, polyacrylate dispersants, acrylic copolymers, polyvinyl alcohol derivatives, block copolymers, and combinations thereof.

5. The pesticidal suspension composition of claim 4, wherein the dispersant is polyether-based polymeric dispersants.

6. The pesticidal suspension composition of claim 1, wherein the surfactant is selected from non-ionic surfactants, anionic surfactants, cationic surfactants, amphoteric surfactants, or combinations thereof.

7. The pesticidal suspension composition of claim 6, wherein the surfactant is the non-ionic surfactants.

8. The pesticidal suspension composition of claim 1, further comprising a thickener.

9. The pesticidal suspension composition of claim 8, wherein the thickener is selected from xanthan gum, cellulose derivatives, polysaccharides, clays, synthetic polymers, or combinations thereof.

10. The pesticidal suspension composition of claim 1, further comprising a preservative.

11. The pesticidal suspension composition of claim 10, wherein the preservative comprises Proxel® GXL, a paraben, or combinations thereof.

12. The pesticidal suspension composition of claim 1, further comprising an antifreeze agent.

13. The pesticidal suspension composition of claim 12, wherein the antifreeze agent comprises propylene glycol, ethylene glycol, glycerol, or combinations thereof.

14. The pesticidal suspension composition of claim 12, wherein the antifreeze agent is present in an amount of up to about 25 wt %.

15. The pesticidal suspension composition of claim 1, further comprising an antifoaming agent.

16. The pesticidal suspension composition of claim 15, wherein the antifoaming agent comprises a silicone-based antifoam.

17. A pesticidal suspension composition comprising:
20-25% indoxacarb by weight of the suspension;
4.5-6% dispersant by weight of the suspension;
1-2% surfactant by weight of the suspension; and
water;
wherein the dispersant and surfactant are present in amounts effective to maintain the indoxacarb as a stable suspension during storage.

18. A pesticidal suspension composition consisting essentially of:
3-30% indoxacarb by weight of the suspension;
4.5-6% dispersant by weight of the suspension;
1-2% surfactant by weight of the suspension; and
water;
wherein the dispersant and surfactant are present in amounts effective to maintain the indoxacarb as a stable suspension during storage.

19. A suspension concentrate comprising:
45-50% indoxacarb by weight of the suspension concentrate;
10-12% dispersant by weight of the suspension concentrate; and
2-5% surfactant by weight of the suspension concentrate;
wherein the dispersant and surfactant are present in amounts effective to maintain the indoxacarb as a stable suspension during storage.

20. The suspension concentrate of claim 19, further comprising an antifreeze agent, an antifoaming agent, a preservative, a thickener, or any combination thereof.

21. A method of controlling pests, the method comprising:
applying an effective amount of a pesticide composition comprising indoxacarb at about 20-21% by weight to a target area to control one or more turfgrass or ornamental pests.

22. The method of claim 21, wherein the pests controlled comprise one or more selected from black cutworm larvae, tawny mole cricket, and Genista caterpillar.

23. The method of claim 21, wherein the target area is cool-season turfgrass, and the pests controlled include black cutworm larvae.

24. The method of claim 21, wherein the target area is warm-season turfgrass, and the pests controlled include tawny mole cricket.

25. The method of claim 21, wherein the target area comprises ornamental plants, and the pests controlled include Genista caterpillar.

26. The method of claim 21, wherein the applying step comprises applying the pesticide composition at a rate of about 0.1 fluid ounces per 1,000 square feet.

27. The method of claim 21, wherein the applying step comprises applying the pesticide composition at a rate ranging from about 0.3 to about 0.9 fluid ounces per 1,000 square feet.

28. The method of claim 21, wherein the applying step comprises applying the pesticide composition at a rate ranging from about 1.1 to about 2.9 fluid ounces per 100 gallons.

29. A method of controlling turfgrass or ornamental pests comprising:
applying to a turfgrass area or ornamental plant an effective amount of a pesticidal composition comprising indoxacarb;
wherein the composition is applied at a rate of about 0.1 to about 0.9 fluid ounces of product per 1,000 square feet of treated area, and wherein the pests controlled are selected from the group consisting of black cutworm, tawny mole cricket, and Genista caterpillar.

30. The method of claim 29, wherein the pesticidal composition comprises about 15% to about 25% indoxacarb by weight.

31. The method of claim 29, wherein the pesticidal composition comprises a dispersant, a surfactant, and water.

32. The method of claim 29, wherein the composition further comprises one or more of a thickener, preservative, antifreeze agent, or antifoaming agent.

33. The method of claim 29, wherein the application controls black cutworm on cool-season turfgrass.

34. The method of claim 29, wherein the application controls tawny mole cricket on warm-season turfgrass.

35. The method of claim 29, wherein the application controls Genista caterpillar on ornamental plants.

36. The method of claim 29, wherein the composition is applied as a spray solution or diluted suspension.

37. A method of controlling pests on ornamental plants, the method comprising:
preparing a spray solution by diluting a pesticidal composition comprising indoxacarb with water,
wherein the pesticidal composition is present in an amount of about 1.1 to about 2.9 fluid ounces of product per 100 gallons of water, and
applying an effective amount of the spray solution to foliage of one or more ornamental plants to control one or more ornamental pests.

38. The method of claim 37, wherein the pesticidal composition comprises about 15% to about 25% by weight indoxacarb.

39. The method of claim 37, wherein the pests comprise Genista caterpillar.

40. The method of claim 37, wherein the application of the spray solution reduces feeding damage by Genista caterpillar on the ornamental plants relative to untreated plants.

41. The method of claim 37, wherein the application of the spray solution controls the pests without causing phytotoxicity to the ornamental plants under labeled use conditions.
